(19) United States
(12) Patent Application Publication
(10) Pub. No.: US 2019/0292342 A1
(43) Pub. Date: Sep. 26, 2019

(54) HARD COAT FILM

(71) Applicant: DAICEL CORPORATION, Osaka-shi, Osaka (JP)

(72) Inventor: Shinji KIKUCHI, Himeji-shi (JP)

(73) Assignee: DAICEL CORPORATION, Osaka-shi, Osaka (JP)

(21) Appl. No.: 16/463,259

(22) PCT Filed: Jul. 28, 2017
(86) PCT No.: PCT/JP2017/027440

§ 371 Date: May 22, 2019

(30) Foreign Application Priority Data
Nov. 25, 2016 (JP) 2016-228915

(51) Int. Cl. C08J 7/04; C08G 77/04

(52) U.S. Cl. CPC C08J 7/047; C08G 77/045; C08J 2379/08; C08J 2301/10; C08J 2367/03; C08J 2483/04

(57) ABSTRACT

Provided is a hard coat film that has not only high surface hardness, but also excellent transparency. The hard coat film includes a substrate and a hard coat layer disposed on at least one side of the substrate. The substrate is selected from a triacetyl cellulose substrate, a polyimide substrate, and a poly(ethylene naphthalate) substrate. The hard coat layer is made of a cured product of a curable composition. The curable composition is a composition that contains a cationically curable silicone resin and a leveling agent. The cationically curable silicone resin is a silicone resin that includes a silsesquioxane unit, includes an epoxy-containing constitutional unit in a proportion of 50 mole percent or more of the totality of all siloxane constitutional units in the silicone resin, and has a number average molecular weight of 1000 to 3000.

### TECHNICAL FIELD

The present invention relates to hard coat films including hard coat layers that are made of cured products of curable compositions. This application claims priority to Japanese Patent Application No. 2016-228915, filed Nov. 25, 2016 to Japan, the entire contents of which are incorporated herein by reference.

### BACKGROUND ART

There are circulating hard coat films each including a substrate (base) and, on one or both sides of the substrate, a hard coat layer having a surface pencil hardness of about 3H. The hard coat layers of the hard coat films are made mainly from UV-curable acrylic monomers (see, for example, Patent Literature (PTL) 1). For higher surface pencil hardness of the hard coat layers, some hard coat films further contain nanoparticles in the hard coat layers.

In contrast, glass is known as a material having extremely high surface hardness. Among such glass, there is known glass that has been subjected to an alkali ion exchange treatment and has a higher surface pencil hardness of up to 9H. Such glass, however, has poor elastic behaviors and workability, is to be produced and processed not by a roll-to-roll process, but by a sheet-to-sheet process. This leads to high production cost.

### CITATION LIST

### Patent Literature

PTL 1: Japanese Unexamined Patent Application Publication (JP-A) No. 2009-279840

### SUMMARY OF INVENTION

### Technical Problem

However, the hard coat films prepared using UV-curable acrylic monomers are not yet considered to have sufficient surface hardness. In general, higher hardness may possibly be obtained by employing multifunctional UV-curable acrylic monomers as the UV-curable acrylic monomers; or by designing the hard coat layer to have a larger thickness.

Disadvantageously, however, these techniques cause the hard coat layer to undergo greater cure shrinkage and consequently cause the hard coat film to suffer from curling and/or cracking. Also disadvantageously, the hard coat layers further containing nanoparticles may haze (whiten) due to aggregation of the nanoparticles when the nanoparticles have poor compatibility with the UV-curable acrylic monomers.

In contrast, the alkali ion exchange treatment of the glass disadvantageously gives a large amount of alkaline wastewater and puts a heavy load on the environment. Further disadvantageously, such glass is heavy and fragile and costs much. Under these circumstances, demands have been made to provide organic materials that offer elastic behaviors and workability at excellent levels and still have high surface hardness.

Under these circumstances, the inventor of the present invention found that a specific curable composition, when cured, can give a cured product having high surface hardness and offering excellent elastic behaviors and workability. However, some of hard coat films each including a hard coat layer formed from such a curable composition on a PET substrate have lower transparency, although having high surface hardness.

Accordingly, the present invention has an object to provide a hard coat film that has not only high surface hardness, but also excellent transparency.

In addition, with recent expanding applications, such hard coat films require, in particular, heat resistance, elastic behaviors (in particular, flexibility), and workability at excellent levels, in addition to the high surface hardness.

### Solution to Problem

After intensive investigations to achieve the objects, the inventor found that a hard coat film having both high surface hardness and excellent transparency can be obtained using a curable composition containing a specific polyorganosilsesquioxane and a leveling agent to form a hard coat layer, and using a substrate selected from a triacetyl cellulose substrate, a polyimide substrate, and a poly(ethylene naphthalate) substrate. The present invention has been made on the basis of these findings.

Specifically, the present invention provides, in an aspect, a hard coat film including a substrate, and a hard coat layer disposed on at least one side of the substrate. The substrate is selected from a triacetyl cellulose substrate, a polyimide substrate, and a poly(ethylene naphthalate) substrate. The hard coat layer is made of a cured product of a curable composition. The curable composition is a composition containing a cationically curable silicone resin and a leveling agent. The cationically curable silicone resin is a silicone resin that includes a silsesquioxane unit, includes an epoxy-containing constitutional unit in a proportion of 50 mole percent or more of the totality of all siloxane constitutional units in the silicone resin, and has a number average molecular weight of 1000 to 3000.

The cationically curable silicone resin preferably includes a constitutional unit represented by Formula (I) in a proportion of 50 mole percent or more of the totality of all siloxane constitutional units in the cationically curable silicone resin, where Formula (I) is expressed as follows:

[R^{a}SiO_{3/2}] (I)

wherein R^{a} is selected from an epoxy-containing group, a hydrocarbon group, and hydrogen.

Preferably, the cationically curable silicone resin further includes a constitutional unit represented by Formula (II) and has a mole ratio of the constitutional unit represented by Formula (I) to the constitutional unit represented by Formula (II) of 5 or more, where Formula (II) is expressed as follows:

[R^{b}SiO_{2/2}(OR^{c})] (II)

wherein R^{b} is selected from an epoxy-containing group, a hydrocarbon group, and hydrogen; and R^{c} is selected from hydrogen and C₁-C₄ alkyl.

Preferably, the cationically curable silicone resin includes, as the silsesquioxane unit, a constitutional unit represented by Formula (1) and a constitutional unit represented by Formula (2), where Formulae (1) and (2) are expressed as follows:

[R¹SiO_{3/2}] (1)

wherein R¹ represents a cycloaliphatic-epoxy-containing group,

[R²SiO_{3/2}] (2)

wherein R² represents optionally substituted aryl.

The difference in elastic modulus (in GPa) between the hard coat layer and the substrate is preferably 10 or less in absolute value.

The cationically curable silicone resin preferably has a molecular weight dispersity of 1.0 to 3.0, where the molecular weight dispersity is the ratio of the weight average molecular weight to the number average molecular weight.

The curable composition preferably further contains an epoxy compound other than the cationically curable silicone resin.

The epoxy compound is preferably a cycloaliphatic epoxy compound.

The epoxy compound is preferably a compound containing a cyclohexene oxide group.

Preferably, the leveling agent is one or more leveling agents selected from the class consisting of silicone leveling agents and fluorine-containing leveling agents and contains one or more groups selected from the class consisting of epoxy-reactive groups and hydrolytically condensable groups.

### Advantageous Effects of Invention

The hard coat film according to the present invention has the configuration and thereby has both high surface hardness and excellent transparency. In addition, the hard coat film has high surface hardness and transparency, and still offers elastic behaviors, workability, and flexibility at excellent levels.

### DESCRIPTION OF EMBODIMENTS

The hard coat film according to the present invention includes a substrate, and a hard coat layer on at least one side of the substrate. The substrate is selected from a triacetyl cellulose substrate, a polyimide substrate, and a poly(ethylene naphthalate) substrate. The hard coat layer is made of a cured product of a specific curable composition. This curable composition is a composition that contains a cationically curable silicone resin and a leveling agent. The cationically curable silicone resin is a silicone resin that includes a silsesquioxane unit, includes an epoxy-containing constitutional unit in a proportion of 50 mole percent or more of the totality of all siloxane constitutional units in the silicone resin, and has a number average molecular weight of 1000 to 3000.

Herein, the curable composition is also referred to as “curable composition for use in the present invention”. The hard coat layer made of a cured product of the curable composition for use in the present invention is also referred to as “hard coat layer in the present invention”.

Hardcoat Layer

The hard coat layer in the present invention is given by applying the curable composition for use in the present invention onto a substrate and curing the applied composition. The curable composition for use in the present invention to form the hard coat layer in the present invention contains a cationically curable silicone resin and a leveling agent.

Cationically Curable Silicone Resin

The cationically curable silicone resin contained in the curable composition for use in the present invention includes a silsesquioxane unit. The silsesquioxane unit is a constitutional unit generally represented by the formula: [RSiO_{3/2}] (a so-called T unit). R in the formula is selected from hydrogen and a monovalent organic group, and is hereinafter defined as above.

The cationically curable silicone resin preferably includes, as the silsesquioxane unit, a constitutional unit represented by Formula (1):

[R¹SiO_{3/2}] (1)

The constitutional unit represented by Formula (1) results from hydrolysis and condensation of a corresponding hydrolyzable trifunctional silane compound (such as an after-mentioned compound represented by Formula (a)).

In Formula (1), R¹ represents an epoxy-containing group (monovalent group). The epoxy-containing group is exemplified typically by known or common groups containing an oxirane ring, such as groups containing a glycidyl group (glycidyl-containing groups) and groups containing a cycloaliphatic epoxy group (cycloaliphatic-epoxy-containing groups).

The cycloaliphatic epoxy group is an epoxy group that contains an alicycle (aliphatic-ring) structure and an epoxy group (oxiranyl group) in a molecule (per molecule) and includes an oxygen atom bonded in a triangular arrangement to two adjacent carbon atoms constituting the alicycle. Non-limiting examples of the alicycle include C₅-C₁₂ alicycles such as cyclopentane, cyclohexane, and cyclooctyl rings. A substituent or substituents such as alkyls may be bonded to one or more of carbon atoms constituting the alicycle.

The glycidyl-containing groups and the cycloaliphatic-epoxy-containing groups are not limited, but preferred are groups represented by Formula (1a), groups represented by Formula (1b), groups represented by Formula (1c), and groups represented by Formula (1d); more preferred are the groups represented by Formula (1a) and the groups represented by Formula (1c); and furthermore preferred are the groups represented by Formula (1a). These are preferred from the viewpoints of curability of the curable composition, and surface hardness and heat resistance of the resulting hard coat layer. Formulae (1a) to (1d) are expressed as follows:

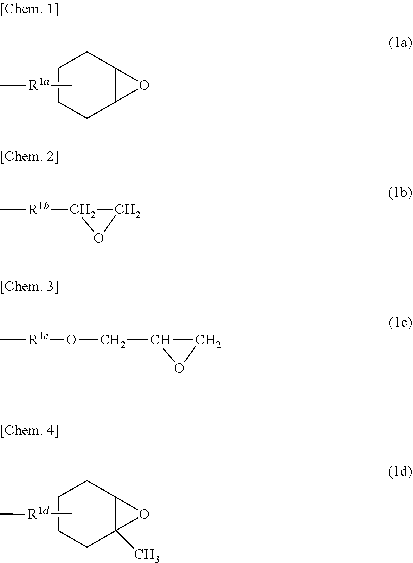

In Formula (1a), R^{1a} represents linear or branched alkylene. Non-limiting examples of the linear or branched alkylene include C₁-C₁₀ linear or branched alkylenes such as methylene, methylmethylene, dimethylmethylene, ethylene, propylene, trimethylene, tetramethylene, pentamethylene, hexamethylene, and decamethylene. Among them, R^{1a} is preferably selected from C₁-C₄ linear (straight-chain) alkylenes and C₃ or C₄ branched (branched-chain) alkylenes; more preferably selected from ethylene, trimethylene, and propylene; and furthermore preferably selected from ethylene and trimethylene. These are preferred from the viewpoints of surface hardness of the hard coat layer and curability.

In Formula (1b), R^{1b} represents linear or branched alkylene and is exemplified by groups as with R^{1a}. Among them, R^{1b} is preferably selected from C₁-C₄ linear alkylenes and C₃ or C₄ branched alkylenes; more preferably selected from ethylene, trimethylene, and propylene; and furthermore preferably selected from ethylene and trimethylene. These are preferred from the viewpoints of surface hardness of the hard coat layer and curability.

In Formula (1c), R^{1c} represents linear or branched alkylene and is exemplified by groups as with Rid. Among them, R^{1c} is preferably selected from C₁-C₄ linear alkylenes and C₃ or C₄ branched alkylenes; more preferably selected from ethylene, trimethylene, and propylene; and furthermore preferably selected from ethylene and trimethylene. These are preferred from the viewpoints of surface hardness of the hard coat layer and curability.

In Formula (1d), R^{1d} represents linear or branched alkylene and is exemplified by groups as with R^{1a}. Among them, R^{1d} is preferably selected from C₁-C₄ linear alkylenes and C₃ or C₄ branched alkylenes; more preferably selected from ethylene, trimethylene, and propylene; and furthermore preferably selected from ethylene and trimethylene. These are preferred from the viewpoints of surface hardness of the hard coat layer and curability.

The constitutional unit may include each of different epoxy-containing groups alone or in combination. In particular from the viewpoint of surface hardness of the hard coat layer, the epoxy-containing group is preferably selected from cycloaliphatic-epoxy-containing groups, and particularly preferably selected from groups represented by Formula (1a) in which R^{1a} is ethylene. In particular, the epoxy-containing group is still more preferably 2-(3,4-epoxycyclohexyl) ethyl.

The cationically curable silicone resin may include each of different constitutional units represented by Formula (1) alone or in combination.

The cationically curable silicone resin may further include a constitutional unit represented by Formula (2) as a silsesquioxane constitutional unit [RSiO_{3/2}] other than the constitutional units represented by Formula (1). Formula (2) is expressed as follows:

[R²SiO_{3/2}] (2)

The constitutional unit represented by Formula (2) is a silsesquioxane constitutional unit (T unit) generally represented by the formula: [RSiO_{3/2}]. Specifically, the constitutional unit represented by Formula (2) results from hydrolysis and condensation of a corresponding hydrolyzable trifunctional silane compound (such as an after-mentioned compound represented by Formula (b)).

In Formula (2), R² is selected from a hydrocarbon group and hydrogen. Examples of the hydrocarbon group include, but are not limited to, alkyls, alkenyls, cycloalkyls, cycloalkenyls, aryls, and aralkyls. Non-limiting examples of the alkyls include linear or branched alkyls such as methyl, ethyl, propyl, n-butyl, isopropyl, isobutyl, s-butyl, t-butyl, and isopentyl, of which C₁-C₁₀ alkyls are typified. Non-limiting examples of the alkenyls include linear or branched alkenyls such as vinyl, allyl, and isopropenyl, of which C₂-C₁₀ alkenyls are typified. Non-limiting examples of the cycloalkyls include cyclobutyl, cyclopentyl, and cyclohexyl, of which C₅-C₁₂ cycloalkyls are typified. Non-limiting examples of the cycloalkenyls include cyclopentenyl and cyclohexenyl, of which C₅-C₁₂ cycloalkenyls are typified. Examples of the aryls include, but are not limited to, phenyl, tolyl, and naphthyl, of which C₆-C₂₀ aryls are typified. Non-limiting examples of the aralkyls include benzyl and phenethyl, of which C₆-C₂₀ aryl-C₁-C₄ alkyls are typified.

The hydrocarbon group may have one or more substituents. Non-limiting examples of the substituents include ether groups, ester groups, carbonyls, siloxane groups, halogens (such as fluorine), acryls, methacryls, mercaptos, aminos, and hydroxys. Non-limiting examples of the substituents also include the hydrocarbon groups, of which C₁-C₄ alkyls such as methyl, and C₆-C₂₀ aryls such as phenyl are generally employed as the substituents.

Among them, R² is preferably selected from optionally substituted aryls, optionally substituted alkyls, and optionally substituted alkenyls; is more preferably selected from optionally substituted aryls; and is furthermore preferably phenyl.

The proportions of the silsesquioxane constitutional units (the constitutional unit represented by Formula (1) and the constitutional unit represented by Formula (2)) in the cationically curable silicone resin may be adjusted as appropriate by the formulation (proportions) of starting materials (hydrolyzable trifunctional silanes) to form these constitutional units.

In an embodiment, the cationically curable silicone resin preferably includes the constitutional unit represented by Formula (1) in which R¹ is a cycloaliphatic-epoxy-containing group, and the constitutional unit represented by Formula (2) in which R² is optionally substituted aryl. The cationically curable silicone resin in this embodiment tends to allow the hard coat layer not only to have still higher surface hardness, but also to offer elastic behaviors, workability, and flame retardancy at excellent levels.

Other than such T units, namely, the constitutional unit represented by Formula (1) and the constitutional unit represented by Formula (2), the cationically curable silicone resin may further include at least one siloxane constitutional unit selected from the class consisting of constitutional units represented by the formula: [R³SiO_{1/2}] (so-called M units), constitutional units represented by the formula: [R²SiO_{2/2}] (so-called D units), and constitutional units represented by the formula: [SiO_{4/2}] (so-called Q units). Non-limiting examples of the group R in the M units and the D units include groups as with R¹ in the constitutional unit represented by Formula (1) and R² in the constitutional unit represented by Formula (2).

The cationically curable silicone resin is a polyorganosilsesquioxane (silsesquioxane) which includes, as the silsesquioxane unit, a constitutional unit represented by Formula (I). This constitutional unit is also referred to as a “T3 species”. Formula (I) is expressed as follows:

[R^{a}SiO_{3/2}] (I)

When described in more detail, the constitutional unit represented by Formula (I) is represented by Formula (I′) below. The three oxygen atoms, which are bonded to the silicon atom specified in the structure represented by Formula (I′), are respectively bonded to other silicon atoms (silicon atoms not shown in Formula (I′)). Specifically, the T3 species is a constitutional unit (T unit) resulting from hydrolysis and condensation of a corresponding hydrolyzable trifunctional silane compound. Formula (I′) is expressed as follows:

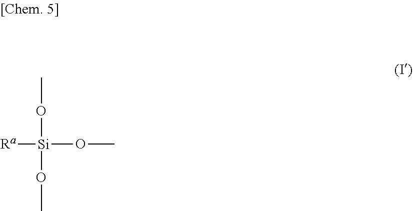

R^{a} in Formula (I) (also R^{a} in Formula (I′)) is selected from an epoxy-containing group, a hydrocarbon group, and hydrogen. Examples of the epoxy-containing group as R^{a} are as with R¹ in Formula (1). Examples of the hydrocarbon group as R^{a} are as with R² in Formula (2). R^{a} in Formula (I) is derived from a group bonded to a silicon atom in the hydrolyzable trifunctional silane compound used as a starting material to form the cationically curable silicone resin for use in the present invention. The group just mentioned above is a group other than alkoxy and halogen and is exemplified typically by, but not limited to, R¹ and R² in after-mentioned Formulae (a) and (b).

In addition to the T3 species, the cationically curable silicone resin preferably further includes, as the silsesquioxane units, a constitutional unit represented by Formula (II). This constitutional unit is also referred to as a “T2 species”. The cationically curable silicone resin for use in the present invention, when further including the T2 species in addition to the T3 species, tends to allow the hard coat layer to have higher surface hardness. This is probably because this cationically curable silicone resin more readily forms an incomplete cage structure (incompletely condensed cage structure). Formula (II) is expressed as follows:

[R^{b}SiO_{2/2}(OR^{c})] (II)

When described in more detail, the constitutional unit represented by Formula (II) is represented by Formula (II′) below. The two oxygen atoms, which are respectively positioned above and below the silicon atom specified in the structure represented by Formula (II′), are bonded respectively to other silicon atoms (silicon atoms not shown in Formula (II′)). Specifically, the T2 species is a constitutional unit (T unit) resulting from hydrolysis and condensation of a corresponding hydrolyzable trifunctional silane compound. Formula (II′) is expressed as follows:

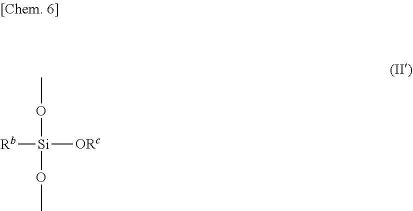

R^{b} in Formula (II) (also R^{b} in Formula (II′)) is selected from an epoxy-containing group, a hydrocarbon group, and hydrogen. Examples of the epoxy-containing group as R^{b} are as with R¹ in Formula (1). Examples of the hydrocarbon group as R^{b} are as with R² in Formula (2). R^{b} in Formula (II) is derived from a group bonded to a silicon atom in the hydrolyzable trifunctional silane compound used as the starting material to form the cationically curable silicone resin. The group just mentioned above is a group other than alkoxy and halogen and is exemplified typically by, but not limited to, R¹ and R² in after-mentioned Formulae (a) and (b).

R^{c} in Formula (II) (also R^{c} in Formula (II′)) is selected from hydrogen and C₁-C₄ alkyl. Non-limiting examples of the C₁-C₄ alkyl include C₁-C₄ linear or branched alkyls such as methyl, ethyl, propyl, isopropyl, butyl, and isobutyl. Among them, R^{c} is preferably selected from methyl and ethyl; and is more preferably methyl. The alkyl as R^{c} in Formula (II) is generally derived from an alkyl moiety constituting an alkoxy group in the hydrolyzable silane compound used as the starting material to form the cationically curable silicone resin. Non-limiting examples of the alkoxy group include alkoxys exemplified as after-mentioned X′ and X².

The mole ratio of the constitutional unit represented by Formula (I) (T3 species) to the constitutional unit represented by Formula (II) (T2 species) in the cationically curable silicone resin is not limited, but is preferably 5 or more, more preferably 5 to 20, furthermore preferably 5 to 18, furthermore preferably 6 to 16, still more preferably 7 to 15, and particularly preferably 8 to 14. The mole ratio of the constitutional unit represented by Formula (I) to the constitutional unit represented by Formula (II) is also referred to as a “T3 to T2 mole ratio”. The cationically curable silicone resin, when having a T3 to T2 mole ratio of 5 or more, tends to allow the hard coat layer to have higher surface hardness.

The T3 to T2 mole ratio in the cationically curable silicone resin may be determined typically by ²⁹Si-NMR spectrum measurement. In a ²⁹Si-NMR spectrum, the silicon atom in the constitutional unit represented by Formula (I) (T3 species) and the silicon atom in the constitutional unit represented by Formula (II) (T2 species) give signals (peaks) at different positions, due to chemical shift. These peaks are each integrated, and the ratio between them is calculated to determine the T3 to T2 mole ratio. Specifically, for example, assume that the cationically curable silicone resin includes a constitutional unit represented by Formula (1) in which R¹ is 2-(3,4-epoxycyclohexyl)ethyl. In this case, the silicon atom in the structure represented by Formula (I) (T3 species) gives a signal appearing at −64 to −70 ppm, whereas the silicon atom in the structure represented by Formula (II) (T2 species) gives a signal appearing at −54 to −60 ppm. On the basis of this, the T3 to T2 mole ratio in this case can be determined by calculating the ratio of the integrated signal at −64 to −70 ppm (assigned to the T3 species) to the integrated signal at −54 to −60 ppm (assigned to the T2 species).

The ²⁹Si-NMR spectrum of the cationically curable silicone resin may be measured typically with an apparatus under conditions as follows:

Measuring apparatus: JNM-ECA500 NMR (trade name, supplied by JEOL Ltd.)

Solvent: deuterated chloroform

Number of scans: 1800

Measurement temperature: 25° C.

Assume that the cationically curable silicone resin has a T3 to T2 mole ratio of 5 or more. This means that the T2 species is present in a proportion at a certain level or higher relative to the T3 species, in the cationically curable silicone resin. Non-limiting examples of the T2 species include constitutional units represented by Formula (3), and constitutional units represented by Formula (4) below. R¹ in Formula (3) and R² in Formula (4) are defined respectively as with R¹ in Formula (1) and R² in Formula (2). R^{c} in Formulae (3) and (4) is selected from hydrogen and C₁-C₄ alkyl, as with R^{c} in Formula (II). Formulae (3) and (4) are expressed as follows:

[R¹SiO_{2/2}(OR^{c})] (3)

[R²SiO_{2/2}(OR^{c})] (4)

The cationically curable silicone resin may be a silsesquioxane having a cage structure (in particular, an incomplete cage structure) (namely, may be a cage silsesquioxane).

In general, a complete-cage (fully condensed cage) silsesquioxane is a polyorganosilsesquioxane that includes the T3 species alone and is devoid of T2 species in a molecule. In other words, when a cationically curable silicone resin has a T3 to T2 mole ratio of 5 or more and gives one intrinsic absorption peak at around 1100 cm⁻¹ in an FT-IR spectrum as described below, it is suggested that this cationically curable silicone resin has an incomplete cage silsesquioxane structure.

Whether a cationically curable silicone resin has a cage (incomplete cage) silsesquioxane structure may be determined by an FT-IR spectrum (reference: R. H. Raney, M. Itoh, A. Sakakibara, and T. Suzuki, Chem. Rev. 95, 1409 (1995)). Specifically, assume that a cationically curable silicone resin does not give intrinsic absorption peaks individually at around 1050 cm⁻¹ and at around 1150 cm⁻¹, but gives one intrinsic absorption peak at around 1100 cm⁻¹ in the FT-IR spectrum. This cationically curable silicone resin can be identified as having a cage (incomplete cage) silsesquioxane structure. In contrast, assume that a cationically curable silicone resin gives intrinsic absorption peaks both at around 1050 cm⁻¹ and at around 1150 cm⁻¹ in the FT-IR spectrum. This cationically curable silicone resin is identified as having a ladder silsesquioxane structure. The FT-IR spectra of the cationically curable silicone resins may be measured typically with an apparatus under conditions as follows:

Measuring apparatus: FT-720 (trade name, supplied by HORIBA, Ltd.)

Measurement method: through transmission

Resolution: 4 cm⁻¹

Measurement wavenumber range: 400 to 4000 cm⁻¹

Number of scans: 16

The proportion (total proportion) of the epoxy-containing constitutional unit or units in the cationically curable silicone resin is 50 mole percent or more, typically 50 to 100 mole percent, preferably 55 to 100 mole percent, more preferably 65 to 99.9 mole percent, furthermore preferably 80 to 99 mole percent, and particularly preferably 90 to 98 mole percent, of the totality (100 mole percent) of siloxane constitutional units (the totality of all siloxane constitutional units: M units, D units, T units, and Q units) in the cationically curable silicone resin. Non-limiting examples of the epoxy-containing constitutional units include the constitutional units represented by Formula (1) and the constitutional units represented by Formula (3). The cationically curable silicone resin, as including the epoxy-containing constitutional unit in a proportion of 50 mole percent or more, allows the curable composition to offer better curability and allows the hard coat layer to have significantly higher surface hardness. The proportions of the individual siloxane constitutional units in the cationically curable silicone resin may be calculated on the basis typically of the formulation (proportions) of starting materials and/or via NMR spectrum measurement.

The proportion of the constitutional unit represented by Formula (I) (T3 species) in the cationically curable silicone resin is not limited, but is preferably 50 mole percent or more, more preferably 60 to 99 mole percent, furthermore preferably 70 to 98 mole percent, still more preferably 80 to 95 mole percent, and particularly preferably 85 to 92 mole percent, of the totality (100 mole percent) of siloxane constitutional units (the totality of all siloxane constitutional units: M units, D units, T units, and Q units) in the cationically curable silicone resin. The cationically curable silicone resin, when including the T3 species constitutional unit in a proportion of 50 mole percent or more, tends to allow the hard coat layer to have higher surface hardness. This is probably because the resulting curable composition tends to more readily form an incomplete cage structure having an appropriate molecular weight.

The proportion (total proportion) of the constitutional unit represented by Formula (2) and the constitutional unit represented by Formula (4) in the cationically curable silicone resin is not limited, but is preferably 0 to 70 mole percent, more preferably 0 to 60 mole percent, furthermore preferably 0 to 40 mole percent, and particularly preferably 1 to 15 mole percent, of the totality (100 mole percent) of siloxane constitutional units (the totality of all siloxane constitutional units: M units, D units, T units, and Q units) in the cationically curable silicone resin. Control of the proportion to 70 mole percent or less gives a relatively higher proportion of the epoxy-containing constitutional unit, and this tends to allow the curable composition to have better curability and tends to allow the hard coat layer to have higher surface hardness.

The proportion (total proportion) of the constitutional unit represented by Formula (I) and the constitutional unit represented by Formula (II) (in particular, the total proportion of the T3 species and the T2 species) in the cationically curable silicone resin is not limited, but is preferably 60 mole percent or more (e.g., 60 to 100 mole percent), more preferably 70 mole percent or more, furthermore preferably 80 mole percent or more, and particularly preferably 90 mole percent or more, of the totality (100 mole percent) of siloxane constitutional units (the totality of all siloxane constitutional units: M units, D units, T units, and Q units) in the cationically curable silicone resin. Control of the proportion to 60 mole percent or more tends to allow the hard coat layer to have higher surface hardness. This is probably because the resulting curable composition tends to more readily form an incomplete cage structure having an appropriate molecular weight. In particular, the proportion (total proportion) of the constitutional unit represented by Formula (1), the constitutional unit represented by Formula (2), the constitutional unit represented by Formula (3), and the constitutional unit represented by Formula (4) preferably falls within the range.

The cationically curable silicone resin has a number-average molecular weight (Mn) of 1000 to 3000, preferably 1000 to 2800, more preferably 1100 to 2600, and furthermore preferably 1500 to 2500, as determined by gel permeation chromatography and calibrated with a polystyrene standard. Control of the number-average molecular weight to 1000 or more allows the hard coat layer to have higher surface hardness, and tends to allow the hard coat layer to have heat resistance and scratch resistance at better levels. In contrast, control of the number-average molecular weight to 3000 or less allows the hard coat layer to have elastic behaviors and workability at better levels. The control also tends to allow the cationically curable silicone resin to have better compatibility with other components in the curable composition and to give a hard coat layer having higher transparency and better heat resistance.

The molecular weight dispersity (Mw/Mn) of the cationically curable silicone resin is not limited, but is preferably 1.0 to 3.0, more preferably 1.1 to 2.0, furthermore preferably 1.2 to 1.9, still more preferably 1.3 to 1.8, and particularly preferably 1.45 to 1.80, as determined by gel permeation chromatography and calibrated with a polystyrene standard. The cationically curable silicone resin, when having a molecular weight dispersity of 3.0 or less, tends to allow the hard coat layer to have higher surface hardness. In contrast, the cationically curable silicone resin, when having a molecular weight dispersity of 1.0 or more (in particular, 1.1 or more), tends to easily become liquid and to offer better handleability.

The number-average molecular weight and the molecular weight dispersity of the cationically curable silicone resin may be measured with an apparatus under conditions as follows:

Measuring apparatus: LC-20AD (trade name, supplied by Shimadzu Corporation)

Columns: two Shodex KF-801 columns, a KF-802 column, and a KF-803 column (supplied by Showa Denko K.K.)

Measurement temperature: 40° C.

Eluent: THF, at a sample concentration of 0.1 to 0.2 weight percent

Flow rate: 1 mL/min.

Detector: UV-VIS detector SPD-20A (trade name, supplied by Shimadzu Corporation)

Molecular weight: calibrated with a polystyrene standard

The 5% weight loss temperature (T_{d5}) in an air atmosphere of the cationically curable silicone resin is not limited, but is preferably 330° C. or higher (e.g., 330° C. to 450° C.), more preferably 340° C. or higher (e.g., 340° C. to 420° C.), and furthermore preferably 350° C. or higher (e.g., 350° C. to 400° C.). The cationically curable silicone resin, when having a 5% weight loss temperature of 330° C. or higher, tends to allow the hard coat layer to have better heat resistance. In particular, the cationically curable silicone resin is controlled to have a 5% weight loss temperature of 330° C. or higher by controlling the cationically curable silicone resin to have a T3 to T2 mole ratio of 5 or more, a number-average molecular weight of 1000 to 3000, and a molecular weight dispersity of 1.0 to 3.0, and to give one intrinsic peak at around 1100 cm⁻¹ in the FT-IR spectrum. The “5% weight loss temperature” refers to a temperature at the time point when a sample heated at a predetermined rate of temperature rise loses 5% of its initial weight (weight before heating). The 5% weight loss temperature serves as an index for heat resistance. The 5% weight loss temperature may be measured by thermogravimetric analysis (TGA) in an air atmosphere at a rate of temperature rise of 5° C./min.

The cationically curable silicone resin can be produced by any of known or common methods for producing polysiloxanes without limitation, but may be produced typically by subjecting one or more hydrolyzable silane compounds, such as silane compounds corresponding to constitutional units in the cationically curable silicone resin, to hydrolysis and condensation. However, the production is performed with the proviso that at least part of the hydrolyzable silane compounds contains an epoxy group; and the epoxy-containing hydrolyzable silane compound is used in such a proportion as to be 50 mole percent or more of the totality of all constitutional units constituting the cationically curable silicone resin.

More specifically, the cationically curable silicone resin may be produced typically by subjecting a compound represented by Formula (a), where necessary in combination with a compound represented by Formula (b), to hydrolysis and condensation, where the compound represented by Formula (a) and the compound represented by Formula (b) are hydrolyzable silane compounds to form silsesquioxane constitutional units (T units) in the cationically curable silicone resin. Formulae (a) and (b) are expressed as follows:

R¹Si(X¹)₃ (a)

R²Si(X²)₃ (b)

The compound represented by Formula (a) is a compound to form the constitutional unit represented by Formula (1) in the cationically curable silicone resin. R¹ in Formula (a) represents an epoxy-containing group, as with R¹ in Formula (1). Specifically, R¹ in Formula (a) is preferably selected from the groups represented by Formula (1a), the groups represented by Formula (1b), the groups represented by Formula (1c), and the groups represented by Formula (1d); more preferably selected from the groups represented by Formula (1a) and the groups represented by Formula (1c); furthermore preferably selected from the groups represented by Formula (1a); and particularly preferably selected from the groups represented by Formula (1a) in which R^{1a} is ethylene. In particular, R¹ is still more preferably 2-(3,4-epoxycyclohexyl) ethyl.

X¹ in Formula (a) is, independently in each occurrence, selected from alkoxy and halogen. Non-limiting examples of the alkoxy as X′ include C₁-C₄ alkoxys such as methoxy, ethoxy, propoxy, isopropyloxy, butoxy, and isobutyloxy. Non-limiting examples of the halogen as X′ include fluorine, chlorine, bromine, and iodine. Among them, each occurrence of X′ is preferably selected from alkoxys, and more preferably selected from methoxy and ethoxy. The three occurrences of X′ may be identical to or different from one another.

The compound represented by Formula (b) is a compound to form the constitutional unit represented by Formula (2) in the cationically curable silicone resin. R² in Formula (b) is selected from a hydrocarbon group and hydrogen, as with R² in Formula (2). Specifically, R² in Formula (b) is preferably selected from optionally substituted aryls, optionally substituted alkyls, and optionally substituted alkenyls; more preferably selected from optionally substituted aryls; and is furthermore preferably phenyl.

X² in Formula (b) is, independently in each occurrence, selected from alkoxy and halogen. Non-limiting examples of X² are as with X¹. In particular, X² is preferably selected from alkoxys, and more preferably selected from methoxy and ethoxy. The three occurrences of X² may be identical to or different from one another.

The hydrolyzable silane compounds for use herein may also include a hydrolyzable silane compound other than the compounds represented by Formulae (a) and (b). Examples of the other hydrolyzable silane compound include, but are not limited to, hydrolyzable trifunctional silane compounds other than the compounds represented by Formulae (a) and (b); hydrolyzable monofunctional silane compounds to form M units; hydrolyzable bifunctional silane compounds to form D units; and hydrolyzable tetrafunctional silane compounds to form Q units.

The amounts and formulation (proportions) of the hydrolyzable silane compounds may be adjusted as appropriate according to the desired structure of the cationically curable silicone resin. For example, the amount of the compound represented by Formula (a) is not limited, but is preferably 50 mole percent or more (e.g., 55 to 100 mole percent), more preferably 65 to 99.9 mole percent, furthermore preferably 80 to 99 mole percent, and particularly preferably 90 to 98 mole percent, of the totality (100 mole percent) of all hydrolyzable silane compounds to be used.

The amount of the compound represented by Formula (b) is not limited, but is preferably 0 to 70 mole percent, more preferably 0 to 60 mole percent, furthermore preferably 0 to 40 mole percent, and particularly preferably 1 to 15 mole percent, of the totality (100 mole percent) of all hydrolyzable silane compounds to be used.

The total proportion (proportion of the totality) of the compound represented by Formula (a) and the compound represented by Formula (b) is not limited, but is preferably 60 to 100 mole percent, more preferably 70 to 100 mole percent, and furthermore preferably 80 to 100 mole percent, of the totality (100 mole percent) of all hydrolyzable silane compounds to be used.

When two or more different hydrolyzable silane compounds are used in combination, the reactions of hydrolysis and condensation of these hydrolyzable silane compounds may be performed simultaneously or non-simultaneously. The reactions, when performed non-simultaneously, may be performed in any sequence.

The hydrolysis and condensation of the hydrolyzable silane compound may be performed in the presence of, or in the absence of, a solvent. In particular, the reaction(s) is preferably performed in the presence of a solvent. Non-limiting examples of the solvent include aromatic hydrocarbons such as benzene, toluene, xylenes, and ethylbenzene; ethers such as diethyl ether, dimethoxyethane, tetrahydrofuran, and dioxane; ketones such as acetone, methyl ethyl ketone, and methyl isobutyl ketone; esters such as methyl acetate, ethyl acetate, isopropyl acetate, and butyl acetate; amides such as N,N-dimethylformamide and N,N-dimethylacetamide; nitriles such as acetonitrile, propionitrile, and benzonitrile; and alcohols such as methanol, ethanol, isopropyl alcohol, and butanol. In particular, the solvent is preferably selected from ketones and ethers. Each of different solvents may be used alone or in combination.

The amount of the solvent is not limited and may be adjusted as appropriate according typically to the desired reaction time, within the range of 0 to 2000 parts by weight per 100 parts by weight of the totality of the hydrolyzable silane compound(s).

The hydrolysis and condensation of the hydrolyzable silane compound(s) is preferably performed in the presence of a catalyst and water. The catalyst may be either an acid catalyst or an alkaline catalyst. Non-limiting examples of the acid catalyst include mineral acids such as hydrochloric acid, sulfuric acid, nitric acid, phosphoric acid, and boric acid; phosphoric esters; carboxylic acids such as acetic acid, formic acid, and trifluoroacetic acid; sulfonic acids such as methanesulfonic acid, trifluoromethanesulfonic acid, and p-toluenesulfonic acid; solid acids such as activated clay; and Lewis acids such as iron chloride. Non-limiting examples of the alkaline catalyst include alkali metal hydroxides such as lithium hydroxide, sodium hydroxide, potassium hydroxide, and cesium hydroxide; alkaline earth metal hydroxides such as magnesium hydroxide, calcium hydroxide, and barium hydroxide; alkali metal carbonates such as lithium carbonate, sodium carbonate, potassium carbonate, and cesium carbonate; alkaline earth metal carbonates such as magnesium carbonate; alkali metal hydrogencarbonates such as lithium hydrogencarbonate, sodium hydrogencarbonate, potassium hydrogencarbonate, and cesium hydrogencarbonate; alkali metal organic acid salts such as lithium acetate, sodium acetate, potassium acetate, and cesium acetate, of which acetates are typified; alkaline earth metal organic acid salts such as magnesium acetate, of which acetates are typified; alkali metal alkoxides such as lithium methoxide, sodium methoxide, sodium ethoxide, sodium isopropoxide, potassium ethoxide, and potassium t-butoxide; alkali metal phenoxides such as sodium phenoxide; amines such as triethylamine, N-methylpiperidine, 1,8-diazabicyclo[5.4.0]undec-7-ene, and 1,5-diazabicyclo[4.3.0]non-5-ene, of which tertiary amines are typified; and nitrogen-containing heteroaromatic compounds such as pyridine, 2,2′-bipyridyl, and 1,10-phenanthroline. Each of different catalysts may be used alone or in combination. The catalyst may also be used as a solution or dispersion typically in water and/or a solvent.

The amount of the catalyst is not limited, and may be adjusted as appropriate within the range of 0.002 to 0.200 mole per mole of the totality of the hydrolyzable silane compound(s).

The amount of water to be used in the hydrolysis and condensation is not limited and may be adjusted as appropriate within the range of 0.5 to 20 moles per mole of the totality of the hydrolyzable silane compound(s).

The water may be added in any manner not limited, and may be added collectively in the whole quantity (totality to be used), or non-collectively. The water, when added non-collectively, may be added continuously or intermittently.

It is important that the reaction conditions for the hydrolysis and condensation of the hydrolyzable silane compound are selected, in particular, so that the resulting cationically curable silicone resin includes the epoxy-containing constitutional unit in a proportion of 50 mole percent or more of the totality of all siloxane constitutional units in the cationically curable silicone resin, and has a number-average molecular weight of 1000 to 3000. The reaction temperature of the hydrolysis and condensation is not limited, but is preferably 40° C. to 100° C., and more preferably 45° C. to 80° C. Control of the reaction temperature within the range tends to enable more efficient control of the proportion of the epoxy-containing constitutional unit and the number-average molecular weight within the ranges and tends to efficiently control the T3 to T2 mole ratio to 5 or more. The reaction time of the hydrolysis and condensation is not limited, but is preferably 0.1 to 10 hours, and more preferably 1.5 to 8 hours. The hydrolysis and condensation may be performed at normal atmospheric pressure, under pressure (under a load), or under reduced pressure. The atmosphere in which the hydrolysis and condensation is performed is not limited and may be any atmosphere exemplified typically by inert gas atmospheres such as nitrogen atmosphere and argon atmosphere; and atmospheres in the presence of oxygen, such as air atmosphere. However, the atmosphere is preferably an inert gas atmosphere.

The hydrolysis and condensation of the hydrolyzable silane compound gives the cationically curable silicone resin including polyorganosilsesquioxane units (polyorganosilsesquioxane) for use in the present invention. After the completion of the hydrolysis and condensation, the catalyst is preferably neutralized so as to restrain the ring opening of the epoxy groups. The obtained cationically curable silicone resin may be separated/purified typically by a separation means such as water washing (rinsing), acid washing, alkali washing, filtration, concentration, distillation, extraction, crystallization, recrystallization, or column chromatography, or by a separation means as any combination of them.

Leveling Agent

The curable composition for use in the present invention contains a leveling agent as an essential component. The presence of the leveling agent in the curable composition for use in the present invention allows the resulting hard coat layer to have higher surface hardness and allows the curable composition for use in the present invention to have lower surface tension. In particular, the curable composition, as containing both the leveling agent and the cationically curable silicone resin in combination, allows the hard coat layer to have a smoothed surface and to have better visual properties such as transparency and gloss, and higher slip (slippery smoothness). In addition, the curable composition, when employing a specific leveling agent, allows the hard coat layer to have surface hardness and scratch resistance at better levels; and the curable composition, when controlled in blending ratio of the specific leveling agent, allows the hard coat layer to have these properties at still better levels.

The leveling agent for use herein may be selected from known or common leveling agents (such as the adduct of ethylene oxide and acetylene glycol). Among them, the leveling agent is preferably selected from silicone leveling agents and fluorine-containing leveling agents, from the viewpoint of allowing the curable composition for use in the present invention to have more satisfactorily lowered surface tension.

Examples of the silicone leveling agents include, but are not limited to, leveling agents having a polyorganosiloxane skeleton. Non-limiting examples of the polyorganosiloxane skeleton include polyorganosiloxanes each including one or more of M units, D units, T units, and Q units, as with the cationically curable silicone resin. In general, polyorganosiloxanes including D units are used. Examples of groups bonded to silicon atoms (silicon atoms constituting siloxane bonds) in the polyorganosiloxane include the hydrocarbon groups exemplified and described as R^{a} in Formula (I). Among them, the groups are preferably selected from C₁-C₄ alkyls, and aryls; are more preferably selected from methyl and phenyl; and are furthermore preferably methyl. The groups bonded to the silicon atoms may be identical to or different from each other. The repetition number (degree of polymerization) of the siloxane units is not limited, but is preferably 2 to 3000, more preferably 3 to 2000, and furthermore preferably 5 to 1000.

Examples of the fluorine-containing leveling agents include, but are not limited to, leveling agents having an aliphatic fluoro-hydrocarbon skeleton. Non-limiting examples of the aliphatic fluoro-hydrocarbon skeleton include fluoro-C₁-C₁₀ alkanes such as fluoromethanes, fluoroethanes, fluoropropanes, fluoroisopropanes, fluorobutanes, fluoroisobutanes, fluoro-t-butanes, fluoropentanes, and fluorohexanes.

The aliphatic fluoro-hydrocarbon skeleton is not limited, as long as at least part of hydrogen atoms is replaced with a fluorine atom, but is preferably an aliphatic perfluoro-hydrocarbon skeleton with all hydrogen atoms being replaced with fluorine atoms. This is preferred from the viewpoints of allowing the hard coat layer to have scratch resistance, slip, and antifouling properties at better levels.

The aliphatic fluoro-hydrocarbon skeleton may be in the form of a polyfluoroalkylene ether skeleton, which is a constitutional repeating unit through an ether bond. Non-limiting examples of the aliphatic fluoro-hydrocarbon group, which is a constitutional repeating unit, include fluoro-C₁-C₄ alkylenes such as fluoromethylene, fluoroethylene, fluoropropylene, and fluoroisopropylene groups. The polyfluoroalkylene ether skeleton may include each of different aliphatic fluoro-hydrocarbon groups alone or in combination. The repetition number (degree of polymerization) of the fluoroalkylene ether unit is not limited, but is preferably 10 to 3000, more preferably 30 to 1000, and furthermore preferably 50 to 500.

The leveling agents may each contain one or more functional groups, from the viewpoint of imparting various functionalities. Non-limiting examples of the functional groups include hydrolytically condensable groups, groups that are reactive with epoxy groups (epoxy-reactive groups), radically polymerizable groups, polyether groups, polyester groups, and polyurethane groups. The silicone leveling agents may contain an aliphatic fluoro-hydrocarbon group, whereas the fluorine-containing leveling agents may contain a polyorganosiloxane group.

Non-limiting examples of the hydrolytically condensable groups include hydroxysilyl; trihalosilyls such as trichlorosilyl; dihalo(C₁-C₄ alkyl)silyls such as dichloromethylsilyl; dihalo(aryl)silyls such as dichlorophenylsilyl; halodi(C₁-C₄ alkyl)silyls such as chlorodimethylsilyl; tri(C₁-C₄ alkoxy)silyls such as trimethoxysilyl and triethoxysilyl; di(C₁-C₄ alkoxy) (C₁-C₄ alkyl)silyls such as dimethoxymethylsilyl and diethoxymethylsilyl; di(C₁-C₄ alkoxy)arylsilyls such as dimethoxyphenylsilyl and diethoxyphenylsilyl; C₁-C₄ alkoxy-di(C₁-C₄ alkyl)silyls such as methoxydimethylsilyl and ethoxydimethylsilyl; (C₁-C₄ alkoxy)diarylsilyls such as methoxydiphenylsilyl and ethoxydiphenylsilyl; and C₁-C₄ alkoxy (C₁-C₄ alkyl)arylsilyls such as methoxymethylphenylsilyl and ethoxymethylphenylsilyl. Among them, tri-(C₁-C₄ alkoxy)silyls are preferred from the viewpoint of reactivity with the cationically curable silicone resin.

Non-limiting examples of the epoxy-reactive groups include hydroxys, aminos, carboxys, acid anhydride groups (such as maleic anhydride group), and isocyanate groups. Among them, preferred are hydroxys, aminos, acid anhydride groups, and isocyanate groups, from the viewpoint of reactivity with the cationically curable silicone resin and with an after-mentioned epoxy compound; and more preferred is hydroxy from the viewpoints of handleability and availability.

Non-limiting examples of the radically polymerizable groups include (meth)acryloyloxy and vinyl; of which (meth)acryloyloxy is preferred.

Non-limiting examples of the polyether groups include polyoxy-C₂-C₄ alkylenes such as polyoxyethylenes, polyoxypropylenes, polyoxybutylenes, and polyoxyethylene-polyoxypropylenes. Among them, polyoxy-C₂ or C₃ alkylenes are preferred, and polyoxyethylenes are more preferred. In the polyether groups, the repetition number (number of moles added) of oxyalkylene moieties is not limited, but is preferably 2 to 1000, more preferably 3 to 100, and furthermore preferably 5 to 50.

Examples of the polyester groups include, but are not limited to, polyester groups each resulting from a reaction between a dicarboxylic acid and a diol, where the dicarboxylic acid is exemplified typically by aromatic dicarboxylic acids such as terephthalic acid, and aliphatic dicarboxylic acids such as adipic acid, and the diol is exemplified typically by aliphatic diols such as ethylene glycol; and polyester groups each resulting from ring-opening polymerization of a cyclic polyester, where the cyclic polyester is exemplified typically by lactones such as caprolactone.

Non-limiting examples of the polyurethane groups include known or common polyester polyurethane groups and polyether polyurethane groups.

The functional group or groups may be bonded to (introduced into) the polyorganosiloxane skeleton or to the aliphatic fluoro-hydrocarbon skeleton directly, or through a linkage group. Non-limiting examples of the linkage group include alkylenes, cycloalkylenes, ether groups, ester groups, amido, urethane groups, and groups each including two or more of them in combination.

The functional group herein is preferably selected from hydrolytically condensable groups and epoxy-reactive groups; is more preferably selected from epoxy-reactive groups; and is furthermore preferably hydroxy. These are preferred from the viewpoint of being reactive with the cationically curable silicone resin and allowing the hard coat layer to have still higher surface hardness.

The hydroxy may be a terminal hydroxy of a (poly)oxyalkylene. Non-limiting examples of such hydroxy-containing leveling agents include silicone leveling agents each resulting from the introduction of a (poly)oxy-C₂ or C₃ alkylene into the side chain of a polyorganosiloxane skeleton; and fluorine-containing leveling agents each resulting from the introduction of an aliphatic fluoro-hydrocarbon group into the side chain of a (poly)oxy-C₂ or C₃ alkylene skeleton.

Non-limiting examples of the hydroxy-containing silicone leveling agents include polyether-modified polyorganosiloxanes each resulting from the introduction of a polyether group into the principal chain or side chain of a polyorganosiloxane skeleton; polyester-modified polyorganosiloxanes each resulting from the introduction of a polyester group into the principal chain or side chain of a polyorganosiloxane skeleton; and silicone-modified (meth)acrylic resins each resulting from the introduction of a polyorganosiloxane into a (meth)acrylic resin. The hydroxy in each of these silicone leveling agents may be possessed by a polyorganosiloxane skeleton and/or may be possessed by a polyether group, a polyester group, or a (meth)acryloyloxy group. Leveling agents of this type may be available as commercial products such as BYK-370, BYK-SILCLEAN 3700, and BYK-SILCLEAN 3720 (each from BYK Japan KK).

The silicone leveling agents usable herein may be selected from commercially available silicone leveling agents. Non-limiting examples of the commercially available silicone leveling agents include products typically under the trade names of BYK-300, BYK-301/302, BYK-306, BYK-307, BYK-310, BYK-315, BYK-313, BYK-320, BYK-322, BYK-323, BYK-325, BYK-330, BYK-331, BYK-333, BYK-337, BYK-341, BYK-344, BYK-345/346, BYK-347, BYK-348, BYK-349, BYK-370, BYK-375, BYK-377, BYK-378, BYK-UV3500, BYK-UV3510, BYK-UV3570, BYK-3550, BYK-SILCLEAN 3700, and BYK-SILCLEAN 3720 (each from BYK Japan KK); the trade names of AC FS 180, AC FS 360, and AC S 20 (each from Algin Chemie); the trade names of POLYFLOW KL-400X, POLYFLOW KL-400HF, POLYFLOW KL-401, POLYFLOW KL-402, POLYFLOW KL-403, and POLYFLOW KL-404 (each from Kyoeisha Chemical Co., Ltd.); the trade names of KP-323, KP-326, KP-341, KP-104, KP-110, and KP-112 (each from Shin-Etsu Chemical Co., Ltd.); and the trade names of LP-7001, LP-7002, 8032 ADDITIVE, 57 ADDITIVE, L-7604, FZ-2110, FZ-2105, 67 ADDITIVE, 8618 ADDITIVE, 3 ADDITIVE, and 56 ADDITIVE (each from Dow Corning Toray Co., Ltd.).

The fluorine-containing leveling agents usable herein may be selected from commercially available fluorine-containing leveling agents. Non-limiting examples of the commercially available fluorine-containing leveling agents for use herein include products under the trade names of Optool DSX and Optool DAC-HP (from Daikin Industries Ltd.); the trade names of Surflon S-242, Surflon S-243, Surflon S-420, Surflon S-611, Surflon S-651, and Surflon S-386 (from AGC Seimi Chemical Co., Ltd.); the trade name of BYK-340 (from BYK Japan KK); the trade names of AC 110a and AC 100a (each from Algin Chemie); the trade names of Megafac F-114, Megafac F-410, Megafac F-444, Megafac EXP TP-2066, Megafac F-430, Megafac F-472SF, Megafac F-477, Megafac F-552, Megafac F-553, Megafac F-554, Megafac F-555, Megafac R-94, Megafac RS-72-K, Megafac RS-75, Megafac F-556, Megafac EXP TF-1367, Megafac EXP TF-1437, Megafac F-558, and Megafac EXP TF-1537 (each from DIC Corporation); the trade names of FC-4430 and FC-4432 (each from Sumitomo 3M Limited); the trade names of FTERGENT 100, FTERGENT 100C, FTERGENT 110, FTERGENT 150, FTERGENT 150CH, FTERGENT A-K, FTERGENT 501, FTERGENT 250, FTERGENT 251, FTERGENT 222F, FTERGENT 208G, FTERGENT 300, FTERGENT 310, and FTERGENT 400SW (each from NEOS Co., Ltd.); and the trade names of PF-136A, PF-156A, PF-151N, PF-636, PF-6320, PF-656, PF-6520, PF-651, PF-652, and PF-3320 (each from Kitamura Chemicals, Co., Ltd.).

The curable composition may include each of different leveling agents alone or in combination. When the curable composition includes two or more different leveling agents in combination, examples of the combination include the combination of two or more different silicone leveling agents; the combination of two or more different fluorine-containing leveling agents; and the combination of a silicone leveling agent or agents with a fluorine-containing leveling agent or agents.

The leveling agent for use herein is preferably selected from fluorine-containing leveling agents, and more preferably selected from fluorine-containing leveling agents containing a polyether group (in particular, a polyoxyethylene group). These are preferred, in particular, from the viewpoints of allowing the hard coat layer to have lower surface free energy and to have better surface smoothness.

The curable composition may contain the leveling agent in a content (proportion) not limited, but preferably 0.001 to 20 parts by weight, more preferably 0.005 to 10 parts by weight, furthermore preferably 0.01 to 5 parts by weight, and particularly preferably 0.025 to 2 parts by weight, per 100 parts by weight of the totality of the cationically curable silicone resin. The curable composition, when containing the leveling agent in a content of 0.001 part by weight or more, tends to allow the hard coat layer to have still better surface smoothness. In contrast, the curable composition, when containing the leveling agent in a content of 20 parts by weight or less, tends to allow the hard coat layer to have still higher surface hardness. The curable composition, when containing the leveling agent in a content within the range, tends to allow the hard coat layer to have higher surface hardness. This function has not been foreseen as a function of leveling agents.

The curable composition for use in the present invention may further contain a curable compound other than the cationically curable silicone resin. In particular, the curable composition for use in the present invention preferably contains an epoxy compound other than the cationically curable silicone resin, as the curable compound other than the cationically curable silicone resin. The epoxy compound other than the cationically curable silicone resin is hereinafter also simply referred to as an “epoxy compound”.

Epoxy Compound

The epoxy compound is an epoxy compound other than the cationically curable silicone resin. The curable composition for use in the present invention, when containing the epoxy compound in addition to the cationically curable silicone resin, can form a hard coat layer that has transparency maintained at satisfactory level, also has still higher surface hardness, and offers elastic behaviors and workability at excellent levels.

The epoxy compound for use herein may be selected from known or common compounds containing one or more epoxy groups (oxirane rings) in a molecule, and is not limited. Non-limiting examples of the epoxy compound include cycloaliphatic epoxy compounds (cycloaliphatic epoxy resins), aromatic epoxy compounds (aromatic epoxy resins), and aliphatic epoxy compounds (aliphatic epoxy resins). Among them, the epoxy compound is preferably selected from cycloaliphatic epoxy compounds.

The cycloaliphatic epoxy compounds may be known or common compounds containing one or more alicycles and one or more epoxy groups in a molecule and are not limited. Non-limiting examples of the cycloaliphatic epoxy compounds include (1) compounds containing a cycloaliphatic epoxy group in a molecule, where the “cycloaliphatic epoxy group” refers to an epoxy group containing an alicycle and an oxygen atom bonded in a triangular arrangement to adjacent two carbon atoms constituting the alicycle; (2) compounds containing an alicycle and an epoxy group directly bonded to the alicycle through a single bond; and (3) compounds containing an alicycle and a glycidyl ether group in a molecule (glycidyl ether epoxy compounds).

The compounds (1) containing a cycloaliphatic epoxy group in a molecule for use herein may be arbitrarily selected from known or common ones. In particular, the cycloaliphatic epoxy group is preferably a cyclohexene oxide group. Of the compounds (1), preferred are compounds represented by Formula (i):

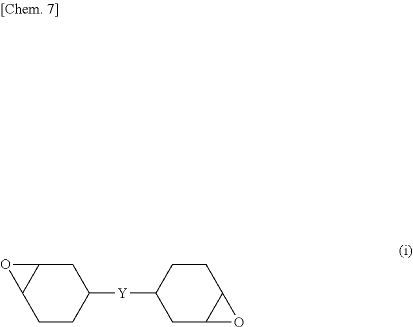

In Formula (i), Y is selected from a single bond and a linkage group (divalent group containing one or more atoms). Non-limiting examples of the linkage group include divalent hydrocarbon groups; alkenylenes with part or all of carbon-carbon double bond(s) being epoxidized; carbonyl; ether bond; ester bond; carbonate group; amido; and groups including two or more of them linked to each other. A substituent such as alkyl may be bonded to one or more of carbon atoms constituting the cyclohexane rings (cyclohexene oxide groups) in Formula (i).

Examples of the divalent hydrocarbon groups include, but are not limited to, C₁-C₁₈ linear or branched alkylenes; and divalent alicyclic hydrocarbon groups. Non-limiting examples of the C₁-C₁₈ linear or branched alkylenes include methylene, methylmethylene, dimethylmethylene, ethylene, propylene, and trimethylene. Non-limiting examples of the divalent alicyclic hydrocarbon groups include divalent cycloalkylenes (including cycloalkylidenes), such as 1,2-cyclopentylene, 1,3-cyclopentylene, cyclopentylidene, 1,2-cyclohexylene, 1,3-cyclohexylene, 1,4-cyclohexylene, and cyclohexylidene.

The alkenylenes with part or all of carbon-carbon double bond(s) being epoxidized are also referred to as “epoxidized alkenylenes”. Non-limiting examples of alkenylenes from which the epoxidized alkenylenes are derived include C₂-C₈ linear or branched alkenylenes such as vinylene, propenylene, 1-butenylene, 2-butenylene, butadienylenes, pentenylenes, hexenylenes, heptenylenes, and octenylenes. In particular, of the epoxidized alkenylenes, preferred are alkenylenes with all of carbon-carbon double bond(s) being epoxidized, and more preferred are C₂-C₄ alkenylenes with all of carbon-carbon double bond(s) being epoxidized.

Representative, but non-limiting examples of the cycloaliphatic epoxy compounds represented by Formula (i) include 3,4,3′,4′-diepoxybicyclohexane; and compounds represented by Formulae (i-1) to (i-10) below. The numbers 1 and m respectively in Formulae (i-5) and (i-7) each independently represent an integer of 1 to 30. R′ in Formula (i-5) represents, independently in each occurrence, C₁-C₈ alkylene and is, in particular, preferably C₁-C₃ linear or branched alkylene such as methylene, ethylene, propylene, or isopropylene. The numbers n1 to n6 in Formulae (i-9) and (i-10) each independently represent an integer of 1 to 30. Non-limiting examples of the cycloaliphatic epoxy compounds represented by Formula (i) also include 2,2-bis(3,4-epoxycyclohexyl)propane, 1,2-bis(3,4-epoxycyclohexyl)ethane, 2,3-bis(3,4-epoxycyclohexyl)oxirane, and bis(3,4-epoxycyclohexylmethyl) ether. Formulae (i-1) to (i-10) are expressed as follows:

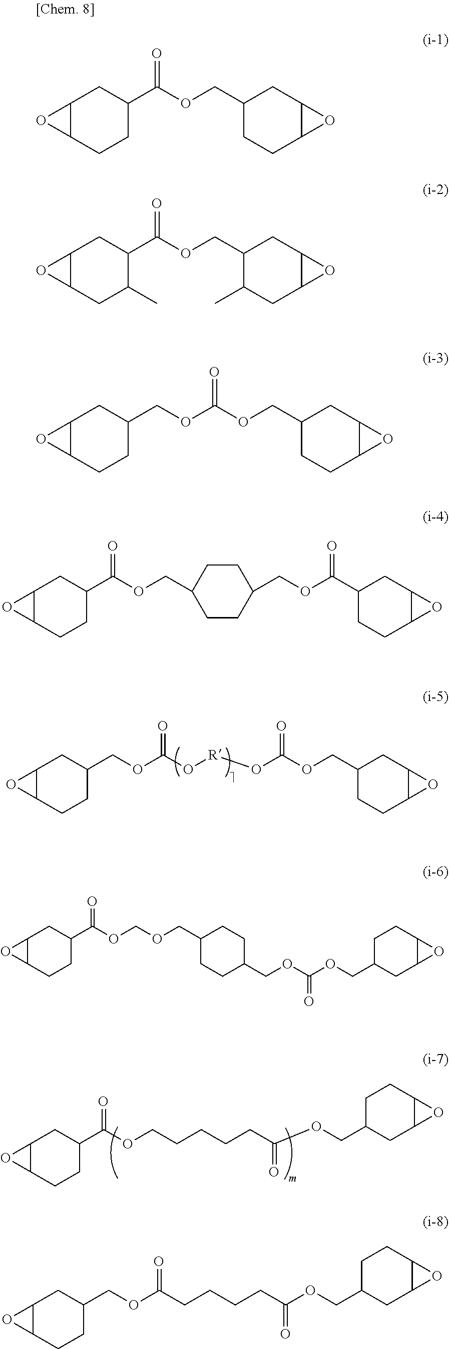

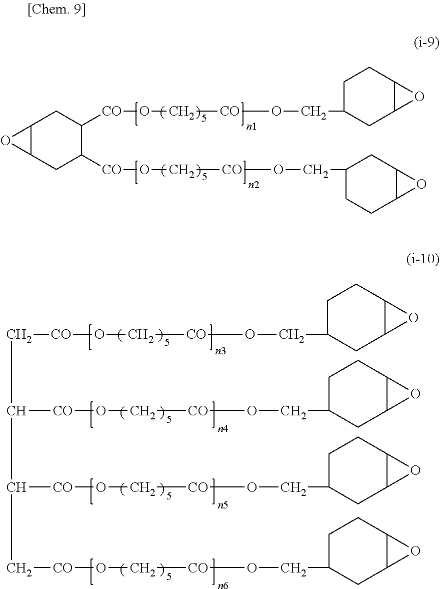

Non-limiting examples of the compounds (2) containing an alicycle and an epoxy group directly bonded to the alicycle through a single bond include compounds represented by Formula (ii):

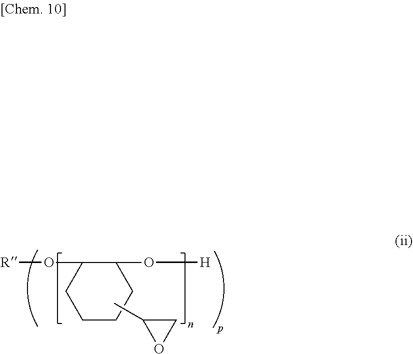

In Formula (ii), R″ is a group (p-valent organic group) resulting from the removal of “p” hydroxy group(s) (—OH) from the structural formula of a p-hydric alcohol; and p and n each independently represent a natural number. Non-limiting examples of the p-hydric alcohol (R″(OH)ₚ) include polyhydric alcohols such as 2,2-bis(hydroxymethyl)-1-butanol, of which C₁-C₁₅ alcohols are typified. The number p is preferably from 1 to 6, and the number n is preferably from 1 to 30. When p is 2 or more, the “p” occurrences of n in the groups in the brackets (outer brackets) may be identical or different. Specifically, a non-limiting example of the compounds represented by Formula (ii) is the adduct of 1,2-epoxy-4-(2-oxiranyl)cyclohexane and 2,2-bis(hydroxymethyl)-1-butanol, such as EHPE 3150 (trade name, supplied by Daicel Corporation).

Examples of the compounds (3) containing an alicycle and a glycidyl ether group in a molecule include, but are not limited to, glycidyl ethers of alicyclic alcohols (in particular, alicyclic polyhydric alcohols). More specifically, non-limiting examples of the compounds (3) include 2,2-bis[4-(2,3-epoxypropoxy)cyclohexyl]propane, 2,2-bis[3,5-dimethyl-4-(2,3-epoxypropoxy)cyclohexyl]propane, and other hydrogenated bisphenol-A epoxy compounds, which are compounds resulting from the hydrogenation of bisphenol-A epoxy compounds; bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, bis[3,5-dimethyl-4-(2,3-epoxypropoxy)cyclohexyl]methane, and other hydrogenated bisphenol-F epoxy compounds, which are compounds resulting from the hydrogenation of bisphenol-F epoxy compounds; hydrogenated biphenol epoxy compounds; hydrogenated phenol novolak epoxy compounds; hydrogenated cresol novolak epoxy compounds; hydrogenated cresol novolak epoxy compounds derived from bisphenol-A; hydrogenated naphthalene epoxy compounds; hydrogenated epoxy compounds resulting from the hydrogenation of epoxy compounds derived from trisphenolmethane; and hydrogenated epoxy compounds derived from aromatic epoxy compounds mentioned below.

Examples of the aromatic epoxy compounds include, but are not limited to, epi-bis glycidyl ether epoxy resins resulting from the condensation of a bisphenol with epihalohydrin, where the bisphenol is exemplified typically by bisphenol-A, bisphenol-F, bisphenol-S, and fluorene-bisphenol; high-molecular-weight epi-bis glycidyl ether epoxy resins resulting from further addition reaction of the epi-bis glycidyl ether epoxy resins with the bisphenol; novolak-alkyl glycidyl ether epoxy resins resulting from the condensation of a phenol with an aldehyde to give a polyhydric alcohol, and further condensation of the polyhydric alcohol with an epihalohydrin, where the phenol is exemplified typically by phenol, cresol, xylenols, resorcinol, catechol, bisphenol-A, bisphenol-F, and bisphenol-S, and the aldehyde is exemplified typically by formaldehyde, acetaldehyde, benzaldehyde, hydroxybenzaldehyde, and salicylaldehyde; and epoxy compounds which include a fluorene ring and two phenolic skeletons bonded at the 9-position of the fluorene ring, in which glycidyl groups are bonded directly or through alkyleneoxy to oxygen atoms resulting from removing hydrogen atoms from the hydroxy groups of these phenolic skeletons.

Non-limiting examples of the aliphatic epoxy compounds include glycidyl ethers of q-hydric alcohols devoid of cyclic structures, where q is a natural number; glycidyl esters of monovalent or multivalent carboxylic acids such as acetic acid, propionic acid, butyric acid, stearic acid, adipic acid, sebacic acid, maleic acid, and itaconic acid; epoxidized derivatives of fats and oils each having a double bond, such as epoxidized linseed oils, epoxidized soybean oils, and epoxidized castor oils; epoxidized derivatives of polyolefins (including polyalkadienes), such as epoxidized polybutadienes. Non-limiting examples of the q-hydric alcohols devoid of cyclic structures include monohydric alcohols such as methanol, ethanol, 1-propyl alcohol, isopropyl alcohol, and 1-butanol; dihydric alcohols such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycols, and polypropylene glycols; and trihydric or higher-hydric alcohols such as glycerol, diglycerol, erythritol, trimethylolethane, trimethylolpropane, pentaerythritol, dipentaerythritol, and sorbitol. The q-hydric alcohols may also be polyether polyols, polyester polyols, polycarbonate polyols, and polyolefin polyols.

The amount (proportion) of the epoxy compound, when contained in the curable composition for use in the present invention, is not limited, but is preferably 0.5 to 100 parts by weight, more preferably 1 to 80 parts by weight, and furthermore preferably 5 to 50 parts by weight, per 100 parts by weight of the totality of the cationically curable silicone resin. The curable composition, when containing the epoxy compound in an amount of 0.5 part by weight or more, tends to allow the hard coat layer to have still higher surface hardness and, in addition, to have elastic behaviors and workability at still better levels, while maintaining satisfactory transparency. In contrast, the curable composition, when containing the epoxy compound in an amount of 100 parts by weight or less, tends to allow the hard coat layer to have still better scratch resistance.

The curable composition for use in the present invention is a curable composition (curable resin composition) including the cationically curable silicone resin and the leveling agent as essential components. The curable composition for use in the present invention may further include one or more other components, as described later. Non-limiting examples of the other components include curing catalysts (in particular, cationic photoinitiators); and surface conditioners or surface modifiers.

The curable composition for use in the present invention may contain each of the cationically curable silicone resins alone or in combination.

The content (proportion) of the cationically curable silicone resin(s) in the curable composition for use in the present invention is not limited, but is preferably from 50 weight percent to less than 100 weight percent, more preferably 60 to 99 weight percent, and furthermore preferably 70 to 95 weight percent, of the totality (100 weight percent) of the curable composition excluding solvents. The curable composition, when containing the cationically curable silicone resin(s) in a content of 50 weight percent or more, tends to allow the hard coat layer to have still higher surface hardness. In contrast, the curable composition, when containing the cationically curable silicone resin in a content of less than 100 weight percent, is allowed to contain the leveling agent and optionally the epoxy compound, and tends to allow the hard coat layer to have higher surface hardness and, in addition, to offer elastic behaviors and workability at still better levels. This curable composition is also allowed to contain the curing catalyst, and this tends to allow the curing of the curable composition to proceed more efficiently.

The proportion of the cationically curable silicone resin in the curable composition for use in the present invention is not limited, but is preferably 50 weight percent or more (e.g., 50 to 100 weight percent), more preferably 60 to 98 weight percent, and furthermore preferably 70 to 95 weight percent, of the totality (100 weight percent) of cationically curable compounds contained in the curable composition. The curable composition, when containing the cationically curable silicone resin in a proportion of 50 weight percent or more, tends to allow the hard coat layer to have still higher surface hardness.

The total content (total proportion) of the cationically curable silicone resin and the epoxy compound in the curable composition for use in the present invention is not limited, but is preferably from 70 weight percent to less than 100 weight percent, more preferably 80 to 99.9 weight percent, and furthermore preferably 90 to 99 weight percent, of the totality (100 weight percent) of the curable composition excluding solvents. The curable composition, when having a total content of the two components of 70 weight percent or more, tends to allow the hard coat layer to have still higher surface hardness and, in addition, to offer elastic behaviors and workability at still better levels. In contrast, the curable composition, when having a total content of the components of less than 100 weight percent, is allowed to contain the leveling agent and tends to allow the hard coat layer to have not only still higher surface hardness, but also elastic behaviors and workability at still better levels. This curable composition is also allowed to contain a curing catalyst, and this tends to allow the curable composition to undergo curing proceeding more efficiently.

The curable composition for use in the present invention preferably further includes a curing catalyst. In particular, the curable composition particularly preferably includes a cationic photoinitiator (photocationic polymerization initiator) as the curing catalyst. This is preferred for a shorter curing time required for the resulting hard coat layer to become tack-free.

The curing catalyst is a compound that can initiate or promote cationic polymerization reactions of cationically curable compounds such as the cationically curable silicone resin and the epoxy compound. Examples of the curing catalyst include, but are not limited to, polymerization initiators such as cationic photoinitiators (photoacid generators) and cationic thermal initiators (thermal acid generators).

The cationic photoinitiators may be selected from known or common cationic photoinitiators and are exemplified by, but are not limited to, sulfonium salts (salts between a sulfonium ion and an anion), iodonium salts (salts between an iodonium ion and an anion), selenium salts (salts between a selenium ion and an anion), ammonium salts (salts between an ammonium ion and an anion), phosphonium salts (salts between a phosphonium ion and an anion), and salts between a transition metal complex ion and an anion. The curable composition may include each of them alone or in combination. Among them, preferred are highly acidic cationic photoinitiators such as sulfonium salts. These are preferred from the viewpoints of giving better reactivity between the cationically curable silicone resin and the epoxy compound and allowing the cured product to have still higher surface hardness.

Non-limiting examples of the sulfonium salts include triarylsulfonium salts such as triphenylsulfonium salts, tri-p-tolylsulfonium salts, tri-o-tolylsulfonium salts, tris(4-methoxyphenyl)sulfonium salts, 1-naphthyldiphenylsulfonium salts, 2-naphthyldiphenylsulfonium salts, tris(4-fluorophenyl)sulfonium salts, tri-1-naphthylsulfonium salts, tri-2-naphthylsulfonium salts, tris(4-hydroxyphenyl)sulfonium salts, diphenyl[4-(phenylthio)phenyl]sulfonium salts, and 4-(p-tolylthio)phenyl-di-(p-phenyl)sulfonium salts; diarylsulfonium salts such as diphenylphenacylsulfonium salts, diphenyl(4-nitrophenacyl)sulfonium salts, diphenylbenzylsulfonium salts, and diphenylmethylsulfonium salts; monoarylsulfonium salts such as phenylmethylbenzylsulfonium salts, 4-hydroxyphenylmethylbenzylsulfonium salts, and 4-methoxyphenylmethylbenzylsulfonium salts; and trialkylsulfonium salts such as dimethylphenacylsulfonium salts, phenacyltetrahydrothiophenium salts, and dimethylbenzylsulfonium salts. Among them, triarylsulfonium salts are preferred.

The diphenyl[4-(phenylthio)phenyl]sulfonium salts may be available as commercial products typically under the trade name of CPI-101A (from San-Apro Ltd., a 50% solution of diphenyl[4-(phenylthio)phenyl]sulfonium hexafluoroantimonate in propylene carbonate), and the trade name of CPI-100P (from San-Apro Ltd., a 50% solution of diphenyl[4-(phenylthio)phenyl]sulfonium hexafluorophosphate in propylene carbonate).

Non-limiting examples of the iodonium salts include UV 9380C (trade name, supplied by Momentive Performance Materials Japan LLC, a 45% solution of bis(4-dodecylphenyl)iodonium hexafluoroantimonate in an alkyl glycidyl ether), RHODORSIL PHOTOINITIATOR 2074 (trade name, supplied by Rhodia Japan, Ltd., [(1-methylethyl)phenyl](methylphenyl)iodonium tetrakis(pentafluorophenyl)borate), WPI-124 (trade name, supplied by Wako Pure Chemical Industries, Ltd.), diphenyliodonium salts, di-p-tolyliodonium salts, bis(4-dodecylphenyl)iodonium salts, and bis(4-methoxyphenyl)iodonium salts.

Examples of the selenium salts include, but are not limited to, triarylselenium salts such as triphenylselenium salts, tri-p-tolylselenium salts, tri-o-tolylselenium salts, tris(4-methoxyphenyl)selenium salts, and 1-naphthyldiphenylselenium salts; diarylselenium salts such as diphenylphenacylselenium salts, diphenylbenzylselenium salts, and diphenylmethylselenium salts; monoarylselenium salts such as phenylmethylbenzylselenium salts; and trialkylselenium salts such as dimethylphenacylselenium salts.

Non-limiting examples of the ammonium salts include tetraalkylammonium salts such as tetramethylammonium salts, ethyltrimethylammonium salts, diethyldimethylammonium salts, triethylmethylammonium salts, tetraethylammonium salts, trimethyl-n-propylammonium salts, and trimethyl-n-butylammonium salts; pyrrolidinium salts such as N,N-dimethylpyrrolidinium salts and N-ethyl-N-methylpyrrolidinium salts; imidazolinium salts such as N,N′-dimethylimidazolinium salts and N,N′-diethylimidazolinium salts; tetrahydropyrimidinium salts such as N,N′-dimethyltetrahydropyrimidinium salts and N,N′-diethyltetrahydropyrimidinium salts; morpholinium salts such as N,N-dimethylmorpholinium salts and N,N-diethylmorpholinium salts; piperidinium salts such as N,N-dimethylpiperidinium salts and N,N-diethylpiperidinium salts; pyridinium salts such as N-methylpyridinium salts and N-ethylpyridinium salts; imidazolium salts such as N,N′-dimethylimidazolium salts; quinolinium salts such as N-methylquinolinium salts; isoquinolinium salts such as N-methylisoquinolinium salts; thiazolium salts such as benzylbenzothiazolium salts; and acridinium salts such as benzylacridinium salts.

Examples of the phosphonium salts include, but are not limited to, tetraarylphosphonium salts such as tetraphenylphosphonium salts, tetra-p-tolylphosphonium salts, and tetrakis(2-methoxyphenyl)phosphonium salts; triarylphosphonium salts such as triphenylbenzylphosphonium salts; and tetraalkylphosphonium salts such as triethylbenzylphosphonium salts, tributylbenzylphosphonium salts, tetraethylphosphonium salts, tetrabutylphosphonium salts, and triethylphenacylphosphonium salts.

Non-limiting examples of the salts of a transition metal complex ion include salts of chromium complex cations such as (η⁵-cyclopentadienyl) (η⁶-toluene)Cr⁺ and (η⁵-cyclopentadienyl) (η⁶-xylene)Cr⁺; and salts of iron complex cations such as (η⁵-cyclopentadienyl) (η⁶-toluene)Fe⁺ and (η⁵-cyclopentadienyl) (η⁶-xylene)Fe⁺.

Non-limiting examples of the anions constituting the salts include SbF₆⁻, PF₆⁻, BF₄⁻, (CF₃CF₂)₃PF₃⁻, (CF₃CF₂CF₂)₃PF₃⁻, (C₆F₅)₄B⁻, (C₆F₅)₄Ga⁻, sulfonate anions (such as trifluoromethanesulfonate anion, pentafluoroethanesulfonate anion, nonafluorobutanesulfonate anion, methanesulfonate anion, benzenesulfonate anion, and p-toluenesulfonate anion), (CF₃SO₂)₃C⁻, (CF₃SO₂)₂N⁻, perhalogen acid ions, halogenated sulfonate ions, sulfate ions, carbonate ions, aluminate ions, hexafluorobismuthate ion, carboxylate ions, arylborate ions, thiocyanate ions, and nitrate ions. Among them, fluorinated alkyl-fluorophosphate ions such as (CF₃CF₂)₃PF₃⁻ and (CF₃CF₂CF₂)₃PF₃⁻ are preferred from the viewpoint of solubility.

Examples of the cationic thermal initiators include, but are not limited to, arylsulfonium salts, aryliodonium salts, allene ion complexes, quaternary ammonium salts, aluminum chelates, and boron trifluoride-amine complexes. The curable composition may include each of them alone or in combination. In particular, highly acidic cationic thermal initiators such as arylsulfonium salts are preferred, from the viewpoints of giving better reactivity between the cationically curable silicone resin and the epoxy compound, and allowing the hard coat layer to have still higher surface hardness. Non-limiting examples of the anions constituting the salts are as with the anions in the cationic photoinitiators.

The arylsulfonium salts are exemplified by, but not limited to, arylsulfonium hexafluoroantimonates. Such arylsulfonium hexafluoroantimonates for use in the curable composition may be available as commercial products typically under the trade names of SP-66 and SP-77 (each from ADEKA CORPORATION); and the trade names of San-Aid SI-60L, San-Aid SI-60S, San-Aid SI-80L, San-Aid SI-100L, and San-Aid SI-150L (each from SANSHIN CHEMICAL INDUSTRY CO., LTD.). Non-limiting examples of the aluminum chelates include aluminum ethylacetoacetate diisopropylate and aluminum tris(ethyl acetoacetate). Non-limiting examples of the boron trifluoride amine complexes include boron trifluoride monoethylamine complex, boron trifluoride imidazole complex, and boron trifluoride piperidine complex.

The curable composition for use in the present invention may include each of different curing catalysts alone or in combination.

The content (proportion) of the curing catalyst in the curable composition for use in the present invention is not limited, but is preferably 0.01 to 10 parts by weight, more preferably 0.05 to 5 parts by weight, furthermore preferably 0.1 to 3 parts by weight, still more preferably 0.3 to 2.7 parts by weight, and particularly preferably 0.5 to 2.5 parts by weight, per 100 parts by weight of the cationically curable silicone resin. The curable composition, when containing the curing catalyst in a proportion of 0.01 part by weight or more, can undergo a curing reaction proceeding efficiently and sufficiently and tends to allow the hard coat layer to have still higher surface hardness. In contrast, the curable composition, when containing the curing catalyst in a proportion of 10 parts by weight or less, tends to allow the hard coat layer to have elastic behaviors and workability at still better levels, tends to have still better storage stability, and/or tends to less invite coloring of the hard coat layer.

The curable composition for use in the present invention may further include a cationically curable compound other than the cationically curable silicone resin and the epoxy compounds. Such other cationically curable compound is also referred to as “other cationically curable compound”. The other cationically curable compound may be selected from known or common cationically curable compounds, is not limited, but is exemplified typically by oxetane compounds and vinyl ether compounds. The curable composition for use in the present invention may include each of different other cationically curable compounds alone or in combination.

The oxetane compounds for use herein may be selected from known or common compounds containing one or more oxetane rings in a molecule, are not limited, but are exemplified typically by 3,3-bis(vinyloxymethyl)oxetane, 3-ethyl-3-(hydroxymethyl)oxetane, 3-ethyl-3-(2-ethylhexyloxymethyl) oxetane, 3-ethyl-3-[(phenoxy)methyl]oxetane, 3-ethyl-3-(hexyloxymethyl)oxetane, 3-ethyl-3-(chloromethyl) oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis{[(3-ethyl-3-oxetanyl)methoxy]methyl}benzene, 3-ethyl-3-{[(3-ethyloxetan-3-yl)methoxy]methyl}}oxetane, xylylene bisoxetanes, 3-ethyl-3-{[3-(triethoxysilyl)propoxy]methyl}oxetane, oxetanylsilsesquioxanes, and phenol novolak oxetanes.

The vinyl ether compounds for use herein may be selected from known or common compounds containing one or more vinyl ether groups in a molecule, are not limited, but are exemplified typically by 2-hydroxyethyl vinyl ether (ethylene glycol monovinyl ether), 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,6-hexanediol divinyl ether, 1,8-octanediol divinyl ether, 1,4-cyclohexanedimethanol monovinyl ether, 1,4-cyclohexanedimethanol divinyl ether, 1,3-cyclohexanedimethanol monovinyl ether, 1,3-cyclohexanedimethanol divinyl ether, 1,2-cyclohexanedimethanol monovinyl ether, 1,2-cyclohexanedimethanol divinyl ether, p-xylene glycol monovinyl ether, p-xylene glycol divinyl ether, m-xylene glycol monovinyl ether, m-xylene glycol divinyl ether, o-xylene glycol monovinyl ether, o-xylene glycol divinyl ether, ethylene glycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, pentaethylene glycol monovinyl ether, pentaethylene glycol divinyl ether, oligoethylene glycol monovinyl ethers, oligoethylene glycol divinyl ethers, polyethylene glycol monovinyl ethers, polyethylene glycol divinyl ethers, dipropylene glycol monovinyl ether, dipropylene glycol divinyl ether, tripropylene glycol monovinyl ether, tripropylene glycol divinyl ether, tetrapropylene glycol monovinyl ether, tetrapropylene glycol divinyl ether, pentapropylene glycol monovinyl ether, pentapropylene glycol divinyl ether, oligopropylene glycol monovinyl ethers, oligopropylene glycol divinyl ethers, polypropylene glycol monovinyl ethers, polypropylene glycol divinyl ethers, isosorbide divinyl ether, oxanorbornene divinyl ether, phenyl vinyl ether, n-butyl vinyl ether, isobutyl vinyl ether, octyl vinyl ether, cyclohexyl vinyl ether, hydroquinone divinyl ether, 1,4-butanediol divinyl ether, cyclohexanedimethanol divinyl ethers, trimethylolpropane divinyl ether, trimethylolpropane trivinyl ether, bisphenol-A divinyl ether, bisphenol-F divinyl ether, hydroxyoxanorbornanemethanol divinyl ethers, 1,4-cyclohexanediol divinyl ether, pentaerythritol trivinyl ether, pentaerythritol tetravinyl ether, dipentaerythritol pentavinyl ether, and dipentaerythritol hexavinyl ether.

The amount (proportion) of the other cationically curable compound(s) in the curable composition for use in the present invention is not limited, but is preferably 50 weight percent or less (e.g., 0 to 50 weight percent), more preferably 30 weight percent or less (e.g., 0 to 30 weight percent), and furthermore preferably 10 weight percent or less, of the totality of the cationically curable silicone resin, the epoxy compound, and the other cationically curable compound(s) (100 weight percent; the totality of all cationically curable compounds). The curable composition, when having an amount of the other cationically curable compound(s) of 50 weight percent or less (in particular, 10 weight percent or less), tends to give a cured product having still better scratch resistance. In contrast, the other cationically curable compound, when contained in an amount of 10 weight percent or more, may give, to the curable composition and the hard coat layer, desired properties. For example, this configuration may impart rapid curability and/or a modified (adjusted) viscosity to the curable composition.

The curable composition for use in the present invention may further include a common additive or additives as other optional components. Non-limiting examples of the additives include fillers exemplified typically by inorganic fillers such as precipitated silica, hydrous silica (wet silica), fumed silica, pyrogenic silica, titanium oxide, alumina, glass, quartz, aluminosilicate, iron oxide, zinc oxide, calcium carbonate, carbon black, silicon carbide, silicon nitride, and boron nitride, as well as inorganic fillers resulting from treatment of these fillers with any of organosilicon compounds such as organohalosilanes, organoalkoxysilanes, and organosilazanes; fine powders of organic resins such as silicone resins, epoxy resins, and fluorocarbon resins; and conductive powders of metals such as silver and copper. Non-limiting examples of the additives also include curing agents such as amine curing agents, polyaminoamide curing agents, acid anhydride curing agents, and phenolic curing agents; curing assistants; curing accelerators such as imidazoles, alkoxides of alkali metals or alkaline earth metals, phosphines, amide compounds, Lewis acid complex compounds, sulfur compounds, boron compounds, and condensable organometallic compounds; solvents such as water and organic solvents; stabilizers such as antioxidants, ultraviolet absorbers, photostabilizers, thermal stabilizers, and heavy-metal deactivators; flame retardants such as phosphorus flame retardants, halogen flame retardants, and inorganic flame retardants; flame retardant promoters; reinforcers such as other fillers; nucleating agents; coupling agents such as silane coupling agents; lubricants; waxes; plasticizers; mold release agents; impact modifiers; color modifiers (hue modifiers); clearing agents; rheology adjusters such as flow improvers; workability improvers; colorants such as dyes and pigments; antistatic agents; dispersants; surface conditioners such as anti-popping agents; surface modifiers such as slipping agents; delustering agents; antifoaming agents; foam inhibitors; defoaming agents; antimicrobial agents; antiseptic agents; viscosity modifiers; thickeners; photosensitizers; and blowing agents. The curable composition may contain each of different additives alone or in combination. The content (proportion) of the additives in the curable composition is not limited, but is preferably 100 parts by weight or less, more preferably 30 parts by weight or less (e.g., 0.01 to 30 parts by weight), and furthermore preferably 10 parts by weight or less (e.g., 0.1 to 10 parts by weight), per 100 parts by weight of the cationically curable silicone resin.

Non-limiting examples of the organic solvents (organic dissolvents) include ketones such as acetone, methyl ethyl ketone, methyl isobutyl ketone, and cyclohexanone; ethers such as dioxane and tetrahydrofuran; aliphatic hydrocarbons such as hexane; alicyclic hydrocarbons such as cyclohexane; aromatic hydrocarbons such as benzene; halogenated hydrocarbons such as dichloromethane and dichloroethane; esters such as methyl acetate and ethyl acetate; alcohols such as ethanol, isopropyl alcohol, butanol, and cyclohexanol; cellosolves such as methyl cellosolve and ethyl cellosolve; cellosolve acetates; and amides such as dimethylformamide and dimethylacetamide.

The curable composition for use in the present invention may be prepared preferably, but non-limitingly, by stirring and mixing the components with each other at room temperature, or with heating as needed. The curable composition for use in the present invention is usable as a one-part composition, or a multi-part (such as two-part) composition. The one-part composition contains the components, which have been blended beforehand, and is used as intact. In contrast, in the multi-part composition, two or more parts (portions) of the components are stored separately, and the two or more parts are blended in predetermined proportions before use.

The proportion of a solvent, when contained in the curable composition for use in the present invention, is not limited, but typically 1 to 90 weight percent, preferably 3 to 50 weight percent, more preferably 5 to 30 weight percent, and furthermore preferably 10 to 20 weight percent. The curable composition, when having a proportion of the solvent of 90 weight percent or less (in particular, 20 weight percent or less), tends to allow the resulting hard coat layer to have better visual properties (such as transparency and smoothness).

The thickness of the hard coat layer in the present invention is not limited, but is preferably 0.1 to 1000 μm, more preferably 1 to 500 μm, furthermore preferably 3 to 200 μm, and particularly preferably 5 to 100 μm. In particular, the hard coat layer in the present invention, even when having a small thickness (for example, a thickness of 5 μm or less), can maintain high surface hardness (e.g., a pencil hardness of H or higher). In contrast, the hard coat layer can have a large thickness so as to have a significantly higher pencil hardness (e.g., a pencil hardness of 9H or higher). This is because the hard coat layer, even when having a large thickness (e.g., a thickness of 50 μm or more), less suffers from defects such as cracking caused typically by cure shrinkage.

The haze of the hard coat layer in the present invention is not limited, but is preferably less than 1.4%, and more preferably 1% or less. The lower limit of the haze is not limited, but is preferably typically 0.1%. In particular, the hard coat layer, when having a haze of 1% or less, tends to allow the hard coat film to be suitably usable in applications that require extremely high transparency, such as applications as display-surface protecting sheets of touch screens (touch panels). The haze of the hard coat layer in the present invention may be measured in conformity to JIS K 7136.

The total luminous transmittance of the hard coat layer in the present invention is not limited, but is preferably 85% or more, and more preferably 90% or more. The upper limit of the total luminous transmittance is not limited, but is preferably typically 99%. The hard coat layer, when having a total luminous transmittance of 85% or more, tends to allow the hard coat film to be suitably usable in applications that require extremely high transparency, such as applications as display-surface protecting sheets of touch screens. The total luminous transmittance of the hard coat layer in the present invention may be measured in conformity to JIS K 7361-1.

The hard coat layer in the present invention may have an elastic modulus not limited, but preferably 1 to 100 GPa, more preferably 2 to 95 GPa, furthermore preferably 4 to 90 GPa, and particularly preferably 5 to 10 GPa. The hard coat layer in the present invention, when having an elastic modulus within the range, allows the hard coat film according to the present invention to have elastic behaviors and workability at still better levels. The elastic modulus of the hard coat layer may be measured typically with a micro-hardness tester.

Substrate

The hard coat film according to the present invention employs a substrate selected from a triacetyl cellulose substrate, a polyimide substrate, and a poly(ethylene naphthalate) substrate. The hard coat film according to the present invention employs the substrate in combination with the hard coat layer in the present invention and thereby has not only high surface hardness, but also excellent transparency, and offers elastic behaviors and workability at excellent levels.

Assume that a poly(ethylene terephthalate) (PET) substrate is used. In this case, production of a highly transparent hard coat film needs a scheme such as providing of a hard coat layer on both sides of the substrate. However, as employing a substrate selected from a triacetyl cellulose substrate, a polyimide substrate, and a poly(ethylene naphthalate) substrate, the hard coat film according to the present invention has excellent transparency even without a scheme as in the use of the PET substrate.

The triacetyl cellulose substrate (triacetyl cellulose film) contains triacetylcellulose (TAC) as a material to constitute the substrate. The content of triacetyl cellulose in the triacetyl cellulose substrate is not limited, but is preferably 50 weight percent or more, more preferably 70 weight percent or more, furthermore preferably 90 weight percent or more, and particularly preferably 95 weight percent or more, of the totality (100 weight percent) of all resins in the substrate. The upper limit of the content may be 100 weight percent.

The polyimide substrate (polyimide film) contains a polyimide as a material to constitute the substrate. The content of the polyimide in the polyimide substrate is not limited, but is preferably 50 weight percent or more, more preferably 70 weight percent or more, furthermore preferably 90 weight percent or more, and particularly preferably 95 weight percent or more, of the totality (100 weight percent) of all resins in the substrate. The upper limit of the content may be 100 weight percent.

The poly(ethylene naphthalate) substrate (poly(ethylene naphthalate) film) contains a poly(ethylene naphthalate) (PEN) as a material to constitute the substrate. The content of the poly(ethylene naphthalate) in the poly(ethylene naphthalate) substrate is not limited, but is preferably 50 weight percent or more, more preferably 70 weight percent or more, furthermore preferably 90 weight percent or more, and particularly preferably 95 weight percent or more, of the totality (100 weight percent) of all resins in the substrate. The upper limit of the content may be 100 weight percent.

Each of the substrates may further include, in addition to the resin (TAC, polyimide, or PEN), any of other resins and/or additives as needed. Non-limiting examples of the additives include antioxidants, ultraviolet absorbers, photostabilizers, thermal stabilizers, crystal nucleators, flame retardants, flame retardant promoters, fillers, plasticizers, impact modifiers, reinforcers, dispersants, antistatic agents, blowing agents, antimicrobial agents, and any other additives. The substrate may include each of different additives alone or in combination.

The substrate may be an unoriented film or an oriented film (such as an uniaxially oriented film or a biaxially oriented film). For example, the triacetyl cellulose substrate and the polyimide substrate are preferably unoriented films, from the viewpoints typically of excellent heat resistance and resistance to iridescence. The poly(ethylene naphthalate) substrate is preferably an oriented film (in particular, a biaxially oriented film), from the viewpoint of excellent heat resistance.

The substrate may have a single-layer structure or a multilayer (stacked) structure and is not limited in configuration (structure). However, substrates constituting such a multilayer substrate are selected from triacetyl cellulose substrates, polyimide substrates, and poly(ethylene naphthalate) substrates.

The surface of the substrate may have undergone, partially or fully, a known or common surface treatment in order typically to improve adhesiveness to the hard coat layer. Non-limiting examples of the surface treatment include roughening treatments, adhesion facilitating treatments, antistatic treatments, sand blasting, discharge treatments (such as corona discharge treatment and glow discharge treatment), plasma treatments, chemical etching, water matting, flame treatments, acid treatments, alkaline treatments, oxidation treatments, ultraviolet irradiation treatments, and silane coupling agent treatments. In particular, corona discharge treatments are preferred.

The thickness of the substrate is not limited, but is preferably 1 to 300 μm, more preferably 10 to 250 μm, furthermore preferably 20 to 200 μm, and particularly preferably 30 to 150 μm, from the viewpoint of transparency.

The haze of the substrate is not limited, but is preferably less than 1.4%, and more preferably 1% or less. The lower limit of the haze is not limited, but may be typically 0.1%. In particular, the substrate, when controlled to have a haze of 1% or less, tends to allow the hard coat film to be suitably usable in applications that require extremely high transparency, such as applications as display-surface protecting sheets of touch screens. The haze of the substrate may be measured in conformity to JIS K 7136.

The total luminous transmittance of the substrate is not limited, but is preferably 85% or more, and more preferably 90% or more. The upper limit of the total luminous transmittance is not limited, but may be typically 99%. The substrate, when controlled to have a total luminous transmittance of 85% or more, tends to allow the hard coat film to be suitably usable in applications that require extremely high transparency, such as applications as display-surface protecting sheets of touch screens. The total luminous transmittance of the substrate may be measured in conformity to JIS K 7361-1.

The elastic modulus of the substrate is not limited, but is preferably 1 to 8 GPa, more preferably 2 to 7 GPa, and furthermore preferably 3 to 6 GPa. The substrate, when having an elastic modulus within the range, allows the hard coat film according to the present invention to have elastic behaviors and workability at still better levels. The elastic modulus of the substrate may be measured typically with a micro-hardness tester.

The substrate can be produced by any known or common technique such as a technique of shaping the material(s) to constitute the substrate into a film as a substrate (film); or a technique of further subjecting the shaped substrate to an appropriate surface treatment. The substrate for use herein may also be available as a commercial product.

### Hard Coat Film

The hard coat film according to the present invention includes the substrate (substrate selected from a triacetyl cellulose substrate, a polyimide substrate, and a poly(ethylene naphthalate) substrate); and the hard coat layer in the present invention disposed on at least one side of the substrate. The hard coat layer in the present invention may be disposed on only one side (only one surface), or on both sides (both surfaces), of the substrate. The hard coat layer in the present invention may be disposed partially or fully on one side of, or on both sides of, the substrate.

The hard coat film according to the present invention may further include another layer than the substrate and the hard coat layer in the present invention. Such other layer is hereinafter also referred to as “other layer”. The hard coat film according to the present invention may include the other layer typically on a side of the substrate where the hard coat layer in the present invention is not present, or between the substrate and the hard coat layer in the present invention. Non-limiting examples of the other layer include hard coat layers other than the hard coat layer in the present invention; and anchor coat layers formed from adhesives or pressure-sensitive adhesives.

The thickness of the hard coat film according to the present invention is not limited, but is preferably 5 to 1000 μm, more preferably 10 to 500 μm, and furthermore preferably 50 to 250 μm. The hard coat film, when having a thickness of 1000 μm or less, tends to have still better elastic behaviors and workability.

The haze of the hard coat film according to the present invention is not limited, but is preferably less than 1.4% (e.g., from 0.05% to less than 1.4%), more preferably 0.1% to 1.3%, furthermore preferably 0.12% to 1%, and still more preferably 0.15% to 0.8%. The hard coat film, when controlled to have a haze of less than 1.4%, tends to be suitably usable in applications that require extremely high transparency, such as applications as display-surface protecting sheets of touch screens. The haze of the hard coat film according to the present invention may be measured in conformity to JIS K 7136.

The total luminous transmittance of the hard coat film according to the present invention is not limited, but is preferably 70% or more (e.g., 70% to 100%), more preferably 80% or more, furthermore preferably 85% or more, and particularly preferably 90% or more. The hard coat film, when having a total luminous transmittance of 70% or more, tends to be suitably usable in applications that require extremely high transparency, such as applications as display-surface protecting sheets of touch screens. The total luminous transmittance of the hard coat film according to the present invention may be measured in conformity to JIS K 7361-1.

In the hard coat film according to the present invention, the difference in elastic modulus (in GPa) between the hard coat layer in the present invention and the substrate is not limited, but is preferably 50 or less (e.g., 0 to 50), more preferably 20 or less, and furthermore preferably 10 or less, in absolute value. The hard coat film, when having a difference in elastic modulus of 50 or less in absolute value, offers still better elastic behaviors and significantly better flexibility.

The flexibility of the hard coat film according to the present invention is not limited, but is preferably 40 mm or less, more preferably 35 mm or less, furthermore preferably 30 mm or less, still more preferably 25 mm or less, still furthermore preferably 20 mm or less, and particularly preferably 10 mm or less, where the flexibility is measured with the hard coat layer facing inward, using cylindrical mandrels in accordance with JIS K 5600-5-1:1999.

The hard coat layer in the present invention has high scratch resistance. The hard coat layer in the present invention of the hard coat film according to the present invention therefore preferably has such a surface as not to be scratched even after 100 reciprocating sliding movements of steel wool #0000 having a diameter of 1 cm under a stress of 1.3 kg/cm².

The hard coat layer in the present invention has excellent smoothness. The arithmetic mean surface roughness Ra of the hard coat layer in the present invention of the hard coat film according to the present invention is not limited, but is preferably 0.1 to 20 nm, more preferably 0.1 to 10 nm, and furthermore preferably 0.1 to 5 nm. The arithmetic mean surface roughness of the hard coat layer may be measured in conformity to JIS B 0601.

The surface water contact angle of the hard coat layer in the present invention of the hard coat film according to the present invention is not limited, but is preferably 60° or more (e.g., 60° to 110°), more preferably 70° to 110°, and furthermore preferably 80° to 110°. The hard coat layer, when having a surface water contact angle of 60° or more, tends to have still better surface scratch resistance.

The surface pencil hardness of the hard coat layer in the present invention of the hard coat film according to the present invention is not limited, but is preferably H or higher (e.g., H to 9H), more preferably 2H or higher, furthermore preferably 3H or higher, still more preferably 4H or higher, still furthermore preferably 5H or higher, and particularly preferably 6H or higher. Control of an aging step, for example, can give a hard coat layer having a pencil hardness of 7H or higher (e.g., 7H to 9H), and preferably 8H or higher. The pencil hardness may be evaluated according to the method prescribed in JIS K 5600-5-4.

The hard coat film according to the present invention may further include a surface-protecting film on the hard coat layer in the present invention. The hard coat film according to the present invention, when including such a surface-protecting film, tends to have still better die cutting workability. For example, assume that the hard coat layer has very high hardness and is susceptible to defects in die cutting, such as separation from the substrate and cracking. Even in this case, the hard coat film, when having such a surface-protecting film, can undergo die cutting using a Thomson blade without suffering from these defects.

The surface-protecting film for use herein may be selected from known or common surface-protecting films, is not limited, but may be selected from ones including a plastic film and a pressure-sensitive adhesive layer disposed on the plastic film. Non-limiting examples of the plastic film include plastic films made from plastic materials exemplified typically by polyesters (such as poly(ethylene terephthalate)s and poly(ethylene naphthalate)s), polyolefins (such as polyethylenes, polypropylenes, and cyclic polyolefins), polystyrenes, acrylic resins, polycarbonates, epoxy resins, fluorocarbon resins, silicone resins, diacetate resins, triacetate resins, polyarylates, poly(vinyl chloride)s, polysulfones, polyethersulfones, poly(ether ether imide)s, polyimides, and polyamides. Non-limiting examples of the pressure-sensitive adhesive layer include pressure-sensitive adhesive layers made of one or more of known or common pressure-sensitive adhesives such as acrylic pressure-sensitive adhesives, natural rubber pressure-sensitive adhesives, synthetic rubber pressure-sensitive adhesives, ethylene-vinyl acetate copolymer pressure-sensitive adhesives, ethylene-(meth)acrylate copolymer pressure-sensitive adhesives, styrene-isoprene block copolymer pressure-sensitive adhesives, and styrene-butadiene block copolymer pressure-sensitive adhesives. The pressure-sensitive adhesive layer may include one or more of additives such as antistatic agents and slipping agents. Each of the plastic film and the pressure-sensitive adhesive layer may independently have a single layer structure or a multi-layer structure. The thickness of the surface-protecting film is not limited and may be selected (determined) as appropriate.

The surface-protecting film is available from the market as commercial products typically under the trade names of SUNYTECT series (from Sun A. Kaken Co., Ltd.), the trade names of E-MASK series (from Nitto Denko Corporation), the trade names of MASTACK series (from Fujimori Kogyo Co., Ltd.), the trade names of HITALEX series (from Hitachi Chemical Company, Ltd.), and the trade names of ALPHAN series (from Oji F-Tex Co., Ltd.).

Production Method

The hard coat film according to the present invention can be produced by applying the curable composition for use in the present invention to at least one side of the substrate (substrate selected from a triacetyl cellulose substrate, a polyimide substrate, and a poly(ethylene naphthalate) substrate), removing the solvent by drying as needed, and curing the curable composition (curable composition layer). Specifically, the curable composition for use in the present invention after application can be cured by allowing the polymerization reaction of cationically curable compounds (such as the cationically curable silicone resin and the epoxy compound) in the curable composition to give a cured product (hard coat layer in the present invention).

The curable composition for use in the present invention may be applied using any known or common coating technique. Non-limiting examples of a coating device include roll coaters, air-knife coaters, blade coaters, rod coaters, reverse coaters, bar coaters, comma coaters, dip and squeeze coaters, die coaters, gravure coaters, micro-gravure coaters, silk-screen coaters, and spray coaters. Non-limiting examples of the coating technique include techniques using such a coating device; dip techniques (dip coating); and techniques using spinners. Among them, coating with a bar coater or a gravure coater is preferred.

The temperature in drying of the curable composition for use in the present invention after application is not limited, but is preferably 40° C. to 200° C., more preferably 50° C. to 180° C., furthermore preferably 60° C. to 150° C., and particularly preferably 120° C. to 150° C. The drying time is also not limited, but is preferably about 30 seconds to about 1 hour. To give a hard coat layer having a pencil hardness approximately equivalent to that of glass, the drying time is preferably 1 minute or longer (e.g., 1 to 30 minutes), more preferably 2 to 25 minutes, and furthermore preferably 3 to 10 minutes.

The curing technique may be selected as appropriate from known techniques, is not limited, but is exemplified typically by a technique of applying at least one of actinic radiation (active energy radiation) and heat. The actinic radiation for use herein may be any actinic radiation such as infrared rays, visible light, ultraviolet radiation, X rays, electron beams, alpha rays, beta rays, and gamma rays. Among them, ultraviolet radiation is preferred for excellent handleability.

The application of the actinic radiation (in particular, electron beams) is preferably performed in an inert gas atmosphere, such as nitrogen atmosphere, argon atmosphere, or helium atmosphere.

Assume that the curable composition for use in the present invention is cured by the application of actinic radiation. Conditions (such as actinic radiation irradiation conditions) in this case may be adjusted as appropriate according typically to the type and energy of the actinic radiation to be applied, and the shape and size (dimensions) of the hard coat film according to the present invention, and are not limited. For example, the application of ultraviolet radiation may be performed at preferably typically about 1 to about 10000 mJ/cm² (more preferably 50 to 10000 mJ/cm², furthermore preferably 70 to 5000 mJ/cm², and still more preferably 100 to 1000 mJ/cm²). For better adhesion to the substrate, the application may be performed at preferably 300 to 10000 mJ/cm², and more preferably 500 to 5000 mJ/cm². The application of the actinic radiation may be performed typically using any of Deep UV lamps, high-pressure mercury lamps, ultra-high pressure mercury lamps, low-pressure mercury lamps, xenon lamps, carbon arc, metal halide lamps, sunlight, LED lamps, halogen lamps, and laser (such as helium-cadmium laser and excimer laser). After the application of the actinic radiation, a heat treatment (annealing, aging) may be performed to allow the curing reaction to further proceed.

When electron beams are applied to cure the curable composition, the dose is not limited, but is preferably 1 to 200 kGy, more preferably 5 to 150 kGy, furthermore preferably 10 to 100 kGy, and particularly preferably 20 to 80 kGy. The acceleration voltage is also not limited, but is preferably 10 to 1000 kV, more preferably 50 to 500 kV, and furthermore preferably 100 to 300 kV.

In contrast, the application of heat, when employed, may be performed under conditions not limited, but is performed at a temperature of typically preferably 30° C. to 200° C., more preferably 50° C. to 190° C., and furthermore preferably 60° C. to 180° C. The curing time may be determined as appropriate.

The production may further include an aging step after curing of the curable composition for use in the present invention to form a hard coat layer. In the aging step, the formed hard coat layer is subjected to a heat treatment (annealing treatment). The heating temperature in the aging step is not limited, but is preferably 30° C. to 200° C., more preferably 50° C. to 190° C., and furthermore preferably 60° C. to 180° C. The heating time is also not limited, but is preferably 10 minutes to 10 hours, more preferably 30 minutes to 5 hours, and furthermore preferably 45 minutes to 3 hours. In particular, to give a hard coat layer having a pencil hardness approximately equivalent to that of glass, the heating is preferably performed at 30° C. to 150° C. (more preferably 50° C. to 120° C., and furthermore preferably 60° C. to 100° C.) for 30 minutes to 5 hours (more preferably 1 to 3 hours, and furthermore preferably 1.5 to 2.5 hours).

The hard coat film according to the present invention has elastic behaviors and workability at excellent levels and can thereby be produced by a roll-to-roll process. The hard coat film, when produced by the roll-to-roll process, can be produced with significantly higher productivity. The method for producing the hard coat film according to the present invention through the roll-to-roll process may be selected from known or common roll-to-roll production methods, is not limited, but is exemplified typically by a method which includes steps A, B, and C as essential steps and which successively performs these steps A, B, and C. The step A is the step of unwinding and feeding a rolled, wound substrate. The step B is the step of applying the curable composition for use in the present invention (curable composition for hard coat layer formation) to at least one surface of the fed substrate, subsequently, as needed, drying the applied curable composition to remove the solvent, and curing the curable composition (curable composition layer) to form a hard coat layer in the present invention to thereby give a hard coat film. The step C is the step of rewinding the resulting hard coat film into a roll. The method may further include one or more other steps in addition to the steps A, B, and C.

In addition, the hard coat film also has excellent die cutting workability particularly when including the surface-protecting film on the hard coat layer in the present invention. The hard coat film is advantageously usable in every use which requires any of these properties.

The hard coat film according to the present invention is usable as components of various products, and as components of members or parts of the products. Non-limiting examples of the products include display devices such as liquid crystal displays and organic electroluminescent (EL) displays; input devices such as touch screens; solar cells; various household electrical appliances; various electric/electronic products; various electric/electronic products exemplified typically by portable electronic terminals such as game equipment, personal computers, tablet computers, smartphones, and cellular phones; and various optical devices.

The hard coat film according to the present invention is also usable typically as a surface-protecting film for various products; and a surface-protecting film for members or parts of various products. A non-limiting example of embodiments in which the hard coat film according to the present invention is used as a component of various products, or as a component of their members or parts is an embodiment in which the hard coat film is used in a multilayer assembly in a touch screen, where the multilayer assembly includes the hard coat film and a transparent conductive film. The hard coat film according to the present invention, when having excellent flexibility, is particularly preferably used as or in a surface-protecting film for flexible displays.

### EXAMPLES

The present invention will be illustrated in further detail with reference to several examples below. It should be noted, however, that the examples are by no means intended to limit the scope of the present invention. Molecular weights of products were measured at 40° C. using Alliance HPLC System 2695 (supplied by Waters Corporation), Refractive Index Detector 2414 (supplied by Waters Corporation), two Tskgel GMHHR-M columns (supplied by Tosoh Corporation) as columns, Tskgel guard column HHRL (supplied by Tosoh Corporation) as a guard column, COLUMN HEATER U-620 (supplied by Sugai) as a column oven, and THF as a solvent. Mole ratios (T3 to T2 ratios) of T3 species to T2 species in the products were measured by ²⁹Si-NMR spectrum measurement using JEOL ECA500 (500 MHz). T_{d5} (5% weight loss temperatures) of the products were measured by thermogravimetric analysis (TGA) in an air atmosphere at a rate of temperature rise of 5° C./min.

### Example 1

Preparation of Cationically Curable Silicone Resin

In a nitrogen stream, 161.5 mmol (39.79 g) of 2-(3,4-epoxycyclohexyl) ethyltrimethoxysilane (hereinafter referred to as “EMS”), 9 mmol (1.69 g) of phenyltrimethoxysilane (hereinafter referred to as “PMS”), and 165.9 g of acetone were placed in a 300-mL flask (reactor) equipped with a thermometer, a stirrer, a reflux condenser, and a nitrogen inlet tube, followed by temperature rise up to 50° C. The resulting mixture was combined with 4.70 g (1.7 mmol in terms of potassium carbonate) of 5% potassium carbonate aqueous solution added dropwise over 5 minutes, and subsequently combined with 1700 mmol (30.60 g) of water added dropwise over 20 minutes. Significant temperature rise did not occur during the dropwise additions. The mixture was then subjected to polycondensation in a nitrogen stream for 4 hours, with the temperature held at 50° C.

A product in the reaction mixture after the polycondensation was analyzed and found to have a number-average molecular weight of 1911 and a molecular weight dispersity of 1.47. The product had a T3 to T2 mole ratio of 10.3, where the T3 to T2 mole ratio is the mole ratio of T3 species to T2 species and was calculated from the ²⁹Si-NMR spectrum of the product.

The reaction mixture was then cooled and rinsed until the lower liquid became neutral. The upper liquid was isolated, from which the solvent was distilled off at 40° C. and 1 mmHg. This gave a colorless, transparent liquid product (cationically curable silicone resin including epoxy-containing silsesquioxane units). The product had a T_{d5} of 370° C.

Production of Hard Coat Film

A solution mixture was prepared and used as a hard-coating composition (curable composition). The solution mixture was a mixture of 84.2 parts by weight of the prepared cationically curable silicone resin (hereinafter also referred to as a “curable resin A”), 14.1 parts by weight of MIBK, 1.3 parts by weight of a cationic photoinitiator, and 0.4 part by weight of a leveling agent.

The prepared hard-coating composition was applied onto a surface of a triacetyl cellulose film (trade name TG80UL (non-oriented film), supplied by FUJIFILM Corporation, having a thickness of 80 μm) using a wire bar #30, left stand (prebaked) in an oven at 150° C. for 2 minutes, and then irradiated with ultraviolet radiation at an irradiance of 400 mJ/cm² for 5 seconds using a high-pressure mercury lamp (supplied by Eye Graphics Co., Ltd.). The resulting article was subjected to a heat treatment (aging treatment) at 150° C. for 30 minutes to cure the applied layer of the hard-coating composition and yielded a hard coat film including a hard coat layer.

### Examples 2 to 5

Hard coat films were produced by a procedure similar to that in Example 1, except for preparing hard-coating compositions (curable compositions) having the formulations given in Table 1; and forming hard coat layers having the thicknesses given in Table 1. In Table 1, proportions of starting materials to form the curable compositions are expressed in part by weight. The symbol “-” in proportions in Table 1 indicates that the component in question was not compounded.

### Example 6

A hard coat film was produced by a procedure similar to that in Example 1, except for using, instead of the triacetyl cellulose film, a polyimide film (trade name OT-050 (non-oriented film), supplied by TAIMIDE TECH. INC., having a thickness of 50 μm).

### Examples 7 to 10

Hard coat films were produced by a procedure similar to that in Example 6, except for preparing hard-coating compositions (curable compositions) having the formulations given in Table 1, and forming hard coat layers having the thicknesses given in Table 1.

### Example 11

A hard coat film was produced by a procedure similar to that in Example 1, except for using, instead of the triacetyl cellulose film, a poly(ethylene naphthalate) film (trade name Teonex Q65HA (biaxially oriented film), supplied by Teijin DuPont Films Japan Limited, having a thickness of 50 μm).

### Examples 12 to 15

Hard coat films were produced by a procedure similar to that in Example 11, except for preparing hard-coating compositions (curable compositions) having the formulations given in Table 2, and forming hard coat layers having the thicknesses given in Table 2. In Table 2, proportions of starting materials to form the curable compositions are expressed in part by weight.

### Comparative Example 1

A hard coat film was produced by a procedure similar to that in Example 1, except for using, instead of the triacetyl cellulose film, a poly(ethylene terephthalate) film (trade name A4300 (biaxially oriented film), supplied by Toyobo Co. Ltd., having a thickness of 188 μm).

### Comparative Examples 2 and 3

Hard coat films were produced by a procedure similar to that in Comparative Example 1, except for preparing hard-coating compositions (curable compositions) having the formulations given in Table 2, and forming hard coat layers having the thicknesses given in Table 2.

### Comparative Examples 4 to 6

Hard coat films were produced by a procedure similar to that in Comparative Example 1, except for preparing hard-coating compositions (curable compositions) having the formulations given in Table 2; forming hard coat layers having the thicknesses given in Table 2; and performing the prebaking at a temperature of 120° C.

The above-prepared hard coat films were evaluated for properties by methods as follows. The results are presented in Tables 1 and 2. The symbol “-” in the evaluations in the tables indicates that the evaluation in question was not performed.

(1) Haze

The above-prepared hard coat films were evaluated for haze of the hard coat layer surface by measurement using a haze meter (trade name NDH-5000W, supplied by Nippon Denshoku Industries Co., Ltd.). The results are presented in “Hz (%)” in Tables 1 and 2.

(2) Iridescence

The above-prepared hard coat films were evaluated for iridescence according to the criteria as follows, by visual observation of the hard coat layer surface in a room under fluorescent lamp irradiation. The results are presented in “Iridescence” in Tables 1 and 2.

Accepted: less iridescence as compared with Comparative Example 1; and

Rejected: iridescence equal to or greater than that in Comparative Example 1.

(3) Surface Hardness (Pencil Hardness)

The above-prepared hard coat films were evaluated for pencil hardness of the hard coat layer surface, in accordance with JIS K 5600-5-4. The evaluation was performed three times, and a result obtained as indicating highest hardness (most hard) was defined as the evaluation result. The results are presented in “Pencil hardness” in Tables 1 and 2.

(4) Bend Test (Cylindrical Mandrel): Through Mandrel Test

The above-prepared hard coat films were evaluated for flexibility, using cylindrical mandrels in accordance with JIS K 5600-5-1:1999, where the test was performed with the hard coat layer facing inward. The results are presented in “Mandrel test (mm in diameter)” in Tables 1 and 2.

(5) Elastic Modulus

The hard coat layer and the substrate were evaluated for elastic modulus by measurement using a micro-hardness tester (trade name ENT-2100, supplied by ELIONIX INC.) under conditions as follows. In Tables 1 and 2, the results of the elastic modulus for the hard coat layer are presented in “Elastic modulus of hard coat layer (GPa)”; and the results for the elastic modulus of the substrate are presented in “Elastic modulus of substrate (GPa)”.

Indenter: Berkovich indenter

Surface detection: load (0.6 mgf)

Load curve: 0.6 mN (linear) over 10 seconds

Creep: 10 seconds at 0.6 mN

Unloading curve: to 0 mN (linear) over 10 seconds

TABLE 1

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple | ple | ple | ple | ple | ple | ple | ple | ple | ple |
| | | | 1 | 2 | 3 | 4 | 5 | 6 | 7 | 8 | 9 | 10 |
| Curable | Weight ratio of cationically | | 100:0 | 90:10 | 90:10 | 90:10 | 90:10 | 100:0 | 90:10 | 90:10 | 90:10 | 90:10 |
| composition | curable silicone resin to | | | | | | | | | | | |
| | epoxy compound | | | | | | | | | | | |
| | Cationically | Curable | 84.2 | 75.8 | 75.8 | 75.8 | 75.8 | 84.2 | 75.8 | 75.8 | 75.8 | 75.8 |
| | curable | resin A | | | | | | | | | | |
| | silicone resin | | | | | | | | | | | |
| | Epoxy | CELLOXIDE | — | 8.4 | — | — | — | — | 8.4 | — | — | — |
| | compound | 2021P | | | | | | | | | | |
| | | Epoxy | — | — | 8.4 | — | — | — | — | 8.4 | — | — |
| | | compound A | | | | | | | | | | |
| | | EHPE 3150 | — | — | — | 8.4 | — | — | — | — | 8.4 | — |
| | | Epoxy | — | — | — | — | 8.4 | — | — | — | — | 8.4 |
| | | compound B | | | | | | | | | | |
| | Solvent | MIBK | 14.1 | 14.1 | 14.1 | 14.1 | 14.1 | 14.1 | 14.1 | 14.1 | 14.1 | 14.1 |
| | Cationic | CPI-210S | 1.3 | 1.3 | 1.3 | 1.3 | 1.3 | 1.3 | 1.3 | 1.3 | 1.3 | 1.3 |
| | photoinitiator | | | | | | | | | | | |
| | Leveling | Surfion | 0.40 | 0.40 | 0.40 | 0.40 | 0.40 | 0.40 | 0.40 | 0.40 | 0.40 | 0.40 |
| | agent | S-243 | | | | | | | | | | |

| | | | | | | | | | | | |
|---|---|---|---|---|---|---|---|---|---|---|---|
| Hard coat | Thickness (μm) | 49 | 51 | 50 | 49 | 51 | 49 | 49 | 55 | 50 | 48 |
| layer | Iridescence | Accept- | Accept- | Accept- | Accept- | Accept- | Accept- | Accept- | Accept- | Accept- | Accept- |
| | | ed | ed | ed | ed | ed | ed | ed | ed | ed | ed |
| | Hz (%) | 0.2 | 0.2 | 0.2 | 0.2 | 0.2 | 0.6 | 0.6 | 0.6 | 0.6 | 0.6 |
| | Pencil hardness | 8H | 9H | 9H | 9H | 9H | 8H | 9H | 9H | 9H | 9H |
| | Mandrel test | 2 | 2 | 2 | 2 | 2 | 2 | 2 | 2 | 2 | 2 |
| | (mm in diameter) | | | | | | | | | | |

| | | | | | | | | | | |
|---|---|---|---|---|---|---|---|---|---|---|
| Elastic modulus of hard coat layer (GPa) | 6.44 | — | — | 5.73 | — | 6.44 | — | — | 5.73 | — |
| Elastic modulus of substrate (GPa) | 3.69 | — | — | 3.69 | — | 4.34 | — | — | 4.34 | — |

TABLE 2

| | | | Exam- | Exam- | Exam- | Exam- | Exam- | | | | | | |
|---|---|---|---|---|---|---|---|---|---|---|---|---|---|
| | | | ple | ple | ple | ple | ple | Comp. | Comp. | Comp. | Comp. | Comp. | Comp. |
| | | | 11 | 12 | 13 | 14 | 15 | Ex. 1 | Ex. 2 | Ex. 3 | Ex. 4 | Ex. 5 | Ex. 6 |
| Curable | Weight ratio of cationically | | 100:0 | 90:10 | 90:10 | 90:10 | 90:10 | 100:0 | 90:10 | 90:10 | 100:0 | 90:10 | 90:10 |
| compo- | curable silicone resin to | | | | | | | | | | | | |
| sition | epoxy compound | | | | | | | | | | | | |
| | Cationically | Curable | 84.2 | 75.8 | 75.8 | 75.8 | 75.8 | 84.2 | 75.8 | 75.8 | 84.2 | 75.8 | 75.8 |
| | curable | resin A | | | | | | | | | | | |
| | silicone resin | | | | | | | | | | | | |
| | Epoxy | CELLOXIDE | — | 8.4 | — | — | — | — | 8.4 | — | — | 8.4 | — |
| | compound | 2021P | | | | | | | | | | | |
| | | Epoxy | — | — | 8.4 | — | — | — | — | — | — | — | — |
| | | compound A | | | | | | | | | | | |
| | | EHPE 3150 | — | — | — | 8.4 | — | — | — | 8.4 | — | — | 8.4 |
| | | Epoxy | — | — | — | — | 8.4 | — | — | — | — | — | — |
| | | compound B | | | | | | | | | | | |
| | Solvent | MIBK | 14.1 | 14.1 | 14.1 | 14.1 | 14.1 | 14.1 | 14.1 | 14.1 | 14.1 | 14.1 | 14.1 |
| | Cationic | CPI-210S | 1.3 | 1.3 | 1.3 | 1.3 | 1.3 | 1.3 | 1.3 | 1.3 | 1.3 | 1.3 | 1.3 |
| | photoinitiator | | | | | | | | | | | | |
| | Leveling | Surfion | 0.40 | 0.40 | 0.40 | 0.40 | 0.40 | 0.40 | 0.40 | 0.40 | 0.40 | 0.40 | 0.40 |
| | agent | S-243 | | | | | | | | | | | |

| | | | | | | | | | | | | |
|---|---|---|---|---|---|---|---|---|---|---|---|---|
| Hard coat | Thickness (μm) | 50 | 50 | 50 | 49 | 50 | 49 | 51 | 49 | 49 | 51 | 49 |
| layer | Iridescence | — | — | — | — | — | — | Reject- | Reject- | Reject- | Reject- | Reject- |
| | | | | | | | | ed | ed | ed | ed | ed |
| | Hz (%) | 0.3 | 0.3 | 0.3 | 0.3 | 0.3 | 2.2 | 2.5 | 2.4 | 1.4 | 1.5 | 1.6 |
| | Pencil hardness | 8H | 9H | 9H | 9H | 9H | 8H | 9H | 9H | 5H | 6H | 5H |
| | Mandrel test | 2 | 2 | 2 | 2 | 2 | 16 | 5 | 5 | 16 | 4 | 5 |
| | (mm in diameter) | | | | | | | | | | | |

| | | | | | | | | | | | |
|---|---|---|---|---|---|---|---|---|---|---|---|
| Elastic modulus of hard coat layer (GPa) | 6.44 | — | — | 5.73 | — | 6.44 | — | 5.73 | — | — | — |
| Elastic modulus of substrate (GPa) | 4.30 | — | — | 4.30 | — | 3.36 | — | 3.36 | — | — | — |

The abbreviations in Tables 1 and 2 indicate as follows.

### Epoxy Compound

CELLOXIDE 2021P: Trade name CELLOXIDE 2021P (3,4-epoxycyclohexylmethyl (3,4-epoxy)cyclohexane carboxylate), supplied by Daicel Corporation

Epoxy compound A: Bis(3,4-epoxycyclohexylmethyl) ether

EHPE 3150: Trade name EHPE 3150 (adduct of 2,2-bis(hydroxymethyl)-1-butanol and 1,2-epoxy-4-(2-oxiranyl) cyclohexane), supplied by Daicel Corporation

Epoxy compound B: 2,2-Bis(3,4-epoxycyclohexyl)propane

### Solvent

MIBK: Methyl isobutyl ketone

### Cationic Photoinitiator

CPI-210S: Trade name CPI-210S, 50% solution of diphenyl[4-(phenylthio)phenyl] tris(pentafluoroethyl)trifluorophosphate in propylene carbonate, supplied by San-Apro Ltd.

### Leveling Agent

Surflon S-243: Trade name Surflon S-243, adduct of a fluorine compound and ethylene oxide, supplied by AGC Seimi Chemical Co., Ltd.

As demonstrated in Tables 1 and 2, all the hard coat films according to the present invention (Examples 1 to 15) had high surface hardness, and offered higher transparency as compared with the hard coat films using poly(ethylene terephthalate) films as a substrate (Comparative Examples 1 to 6). The hard coat films according to the present invention offered excellent elastic behaviors as having excellent flexibility. In addition, the hard coat films of Examples 1 to 10 according to the present invention did not suffer from iridescence, whereas the hard coat films using poly(ethylene terephthalate) films as substrates (Comparative Example 1 to 6) suffered from iridescence.

As a summary of the above description, the configurations according to embodiments of the present invention, as well as variations thereof, will be listed below as appendices.

(1) A hard coat film including a substrate selected from a triacetyl cellulose substrate, a polyimide substrate, and a poly(ethylene naphthalate) substrate, and a hard coat layer being disposed on at least one side of the substrate and being made of a cured product of a curable composition, the curable composition containing a cationically curable silicone resin and a leveling agent, the cationically curable silicone resin being a silicone resin that includes a silsesquioxane unit, includes an epoxy-containing constitutional unit in a proportion of 50 mole percent or more of the totality of all siloxane constitutional units in the silicone resin, and has a number average molecular weight of 1000 to 3000.

(2) The hard coat film according to (1), wherein the cationically curable silicone resin includes a constitutional unit represented by Formula (I) in a proportion of 50 mole percent or more of the totality of all siloxane constitutional units, where Formula (I) is expressed as follows:

[R^{a}SiO_{3/2}] (I)

wherein R^{a} is selected from an epoxy-containing group, a hydrocarbon group, and hydrogen.

(3) The hard coat film according to (2), wherein the cationically curable silicone resin further includes a constitutional unit represented by Formula (II), and wherein the mole ratio of the constitutional unit represented by Formula (I) to the constitutional unit represented by Formula (II) is 5 or more, where Formula (II) is expressed as follows:

[R^{b}SiO_{2/2}(OR^{c})] (II)

wherein R^{b} is selected from an epoxy-containing group, a hydrocarbon group, and hydrogen; and R^{c} is selected from hydrogen and C₁-C₄ alkyl.

(4) The hard coat film according to any one of (1) to (3), wherein the cationically curable silicone resin includes, as the silsesquioxane unit, a constitutional unit represented by Formula (1):

[R¹SiO_{3/2}] (1)

wherein R¹ represents a cycloaliphatic-epoxy-containing group.

(5) The hard coat film according to any one of (1) to (3), wherein the cationically curable silicone resin includes, as the silsesquioxane unit, a constitutional unit represented by Formula (1) and a constitutional unit represented by Formula (2), where Formulae (1) and (2) are expressed as follows:

[R¹SiO_{3/2}] (1)

wherein R¹ represents a cycloaliphatic-epoxy-containing group,

[R²SiO_{3/2}] (2)

wherein R² represents optionally substituted aryl.

(6) The hard coat film according to one of (4) and (5), wherein R¹ is one or more groups selected from the class consisting of groups represented by Formula (1a), groups represented by Formula (1b), groups represented by Formula (1c), and groups represented by Formula (1d) (is preferably at least one of a group represented by Formula (1a) and a group represented by Formula (1c), and is more preferably a group represented by Formula (1a)), where formulae (1a), (1b), (1c), and (1c) are expressed as follows:

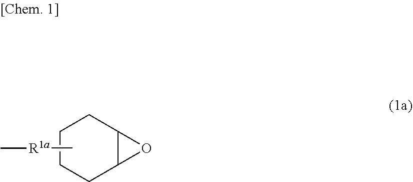

wherein R^{1a} represents linear or branched alkylene,

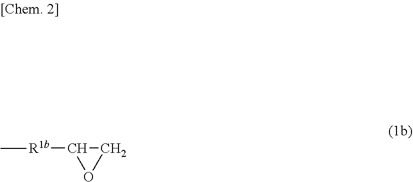

wherein R^{1b} represents linear or branched alkylene,

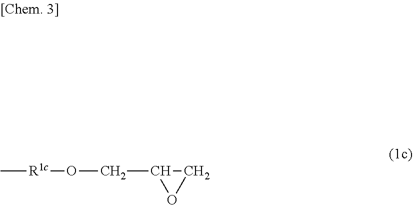

wherein R^{1c} represents linear or branched alkylene,

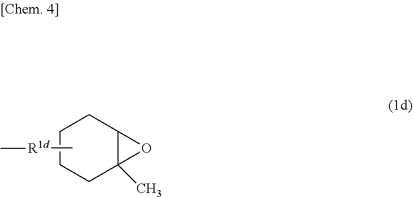

wherein Rid represents linear or branched alkylene.

(7) The hard coat film according to one of (4) and (5), wherein R¹ is 2-(3,4-epoxycyclohexyl)ethyl.

(8) The hard coat film according to any one of (1) to (7), wherein the cationically curable silicone resin has a total proportion of a constitutional unit represented by Formula (2) and a constitutional unit represented by Formula (4) of 0 to 70 mole percent of the totality of all siloxane constitutional units in the cationically curable silicone resin, where Formulae (2) and (4) are expressed as follows:

[R²SiO_{3/2}] (2)

[R²SiO_{2/2}(OR^{c})] (4)

wherein R² represents optionally substituted aryl.

(9) The hard coat film according to any one of (1) to (8), wherein the cationically curable silicone resin has a total proportion of a constitutional unit represented by Formula (I) and a constitutional unit represented by Formula (II) of 60 mole percent or more of the totality of all siloxane constitutional units in the cationically curable silicone resin, where Formulae (I) and (II) are expressed as follows:

[R^{a}SiO_{3/2}] (I)

wherein R^{a} is selected from an epoxy-containing group, a hydrocarbon group, and hydrogen,

[R^{b}SiO_{2/2}(OR^{c})] (II)

wherein R^{b} is selected from an epoxy-containing group, a hydrocarbon group, and hydrogen; and R^{c} is selected from hydrogen and C₁-C₄ alkyl.

(10) The hard coat film according to any one of (1) to (9), wherein the difference in elastic modulus (in GPa) between the hard coat layer and the substrate is 10 or less in absolute value.

(11) The hard coat film according to any one of (1) to (10), wherein the cationically curable silicone resin has a molecular weight dispersity (ratio of weight average molecular weight to number average molecular weight) of 1.0 to 3.0.

(12) The hard coat film according to any one of (1) to (11), wherein the curable composition further contains an epoxy compound other than the cationically curable silicone resin.

(13) The hard coat film according to (12), wherein the epoxy compound is a cycloaliphatic epoxy compound.

(14) The hard coat film according to (12), wherein the epoxy compound is a compound containing a cyclohexene oxide group.

(15) The hard coat film according to any one of (12) to (14), wherein the curable composition contains the epoxy compound in a proportion of 0.5 to 100 parts by weight per 100 parts by weight of the totality of the cationically curable silicone resin.

(16) The hard coat film according to any one of (12) to (15), wherein the curable composition contains the cationically curable silicone resin and the epoxy compound in a total content of from 70 weight percent to less than 100 weight percent of the totality of the curable composition excluding solvents.

(17) The hard coat film according to any one of (1) to (16), wherein the leveling agent includes a silicone leveling agent or a fluorine-containing leveling agent.

(18) The hard coat film according to any one of (1) to (17), wherein the leveling agent contains a hydrolytically condensable group or an epoxy-reactive group.

(19) The hard coat film according to any one of (1) to (18), wherein the leveling agent is one or more leveling agents selected from the class consisting of silicone leveling agents and fluorine-containing leveling agents, and wherein the leveling agent contains one or more groups selected from the class consisting of epoxy-reactive groups and hydrolytically condensable groups.

(20) The hard coat film according to any one of (1) to (19), wherein the leveling agent includes a fluorine-containing leveling agent containing a polyether group (in particular, a polyoxyethylene group).

(21) The hard coat film according to any one of (1) to (20), wherein the curable composition contains the leveling agent in a proportion of 0.001 to 20 parts by weight per 100 parts by weight of the totality of the cationically curable silicone resin.

(22) The hard coat film according to any one of (1) to (21), wherein the curable composition contains the cationically curable silicone resin in a content of from 50 weight percent to less than 100 weight percent of the totality of the curable composition excluding solvents.

(23) The hard coat film according to any one of (1) to (22), wherein the hard coat layer has an elastic modulus of 1 to 100 GPa.

(24) The hard coat film according to any one of (1) to (23), wherein the substrate has a thickness of 1 to 300 μm.

(25) The hard coat film according to any one of (1) to (24), wherein the substrate has a haze of less than 1.4%.

(26) The hard coat film according to any one of (1) to (25), wherein the substrate has a total luminous transmittance of 85% or more.

(27) The hard coat film according to any one of (1) to (26), wherein the substrate has an elastic modulus of 1 to 8 GPa.

(28) The hard coat film according to any one of (1) to (27), wherein the hard coat film has a thickness of 5 to 1000 μm.

(29) The hard coat film according to any one of (1) to (28), wherein the hard coat film has a haze of less than 1.4%.

(30) The hard coat film according to any one of (1) to (29), wherein the hard coat film has a total luminous transmittance of 70% or more.

(31) The hard coat film according to any one of (1) to (30), wherein the hard coat film has a flexibility of 40 mm or less, where the flexibility is measured with the hard coat layer facing inward, using cylindrical mandrels in accordance with JIS K 5600-5-1:1999.

(32) The hard coat film according to any one of (1) to (31), wherein the hard coat layer has such a surface as not to be scratched even after 100 reciprocating sliding movements of steel wool #0000 having a diameter of 1 cm under a stress of 1.3 kg/cm².

(33) The hard coat film according to any one of (1) to (32), wherein the hard coat layer has an arithmetic mean surface roughness Ra of 0.1 to 20 nm.

(34) The hard coat film according to any one of (1) to (33), wherein the hard coat layer has a surface water contact angle of 60° or more.

(35) The hard coat film according to any one of (1) to (34), wherein the hard coat layer has a surface pencil hardness of 8H or higher.

### INDUSTRIAL APPLICABILITY

The hard coat film according to the present invention is usable as components of various products, and as components of members or parts of such products. Non-limiting examples of the products include display devices such as liquid crystal displays and organic electroluminescent (EL) displays; input devices such as touch screens; solar cells; various household electrical appliances; various electric/electronic products; various electric/electronic products exemplified typically by portable electronic terminals such as game equipment, personal computers, tablet computers, smartphones, and cellular phones; and various optical devices.

1. A hard coat film comprising:
a substrate selected from:
a triacetyl cellulose substrate;
a polyimide substrate; and
a poly(ethylene naphthalate) substrate; and
a hard coat layer disposed on at least one side of the substrate, the hard coat layer made of a cured product of a curable composition,
the curable composition containing:
a cationically curable silicone resin; and
a leveling agent,
the cationically curable silicone resin being a silicone resin that includes a silsesquioxane unit, includes an epoxy-containing constitutional unit in a proportion of 50 mole percent or more of the totality of all siloxane constitutional units in the silicone resin, and has a number average molecular weight of 1000 to 3000.

2. The hard coat film according to claim 1,
wherein the cationically curable silicone resin includes a constitutional unit represented by Formula (I) in a proportion of 50 mole percent or more of the totality of all siloxane constitutional units in the cationically curable silicone resin, where Formula (I) is expressed as follows:
[R^{a}SiO_{3/2}] (I)
wherein R^{a} is selected from an epoxy-containing group, a hydrocarbon group, and hydrogen.

3. The hard coat film according to claim 2,
wherein the cationically curable silicone resin further includes a constitutional unit represented by Formula (II), and
wherein the cationically curable silicone resin has a mole ratio of the constitutional unit represented by Formula (I) to the constitutional unit represented by Formula (II) of 5 or more, where Formula (II) is expressed as follows:
[R^{b}SiO_{2/2}(OR^{c})] (II)
wherein R^{b} is selected from an epoxy-containing group, a hydrocarbon group, and hydrogen; and R^{c} is selected from hydrogen and C₁-C₄ alkyl.

4. The hard coat film according to claim 1,
wherein the cationically curable silicone resin includes, as the silsesquioxane unit:
a constitutional unit represented by Formula (1); and
a constitutional unit represented by Formula (2),
where Formulae (1) and (2) are expressed as follows:
[R¹SiO_{3/2}] (1)
wherein R¹ represents a group containing a cycloaliphatic epoxy group,
[R²SiO_{3/2}] (2)
wherein R² represents optionally substituted aryl.

5. The hard coat film according to claim 1,
wherein a difference in elastic modulus (in GPa) between the hard coat layer and the substrate is 10 or less in absolute value.

6. The hard coat film according to claim 1,
wherein the cationically curable silicone resin has a molecular weight dispersity (ratio of weight average molecular weight to number average molecular weight) of 1.0 to 3.0.

7. The hard coat film according to claim 1,
wherein the curable composition further contains an epoxy compound other than the cationically curable silicone resin.

8. The hard coat film according to claim 7,
wherein the epoxy compound is a cycloaliphatic epoxy compound.

9. The hard coat film according to claim 7,
wherein the epoxy compound is a compound containing a cyclohexene oxide group.

10. The hard coat film according to claim 1,
wherein the leveling agent includes one or more leveling agents selected from the class consisting of:
silicone leveling agents; and
fluorine-containing leveling agents, and
wherein the leveling agent contains one or more groups selected from the class consisting of:
epoxy-reactive groups; and
hydrolytically condensable groups.

11. The hard coat film according to claim 4,
wherein R¹ is one or more groups selected from the class consisting of groups represented by Formula (1a), groups represented by Formula (1b), groups represented by Formula (1c), and groups represented by Formula (1d) (is preferably at least one of a group represented by Formula (1a) and a group represented by Formula (1c), and is more preferably a group represented by Formula (1a)), where formulae (1a), (1b), (1c), and (1c) are expressed as follows: 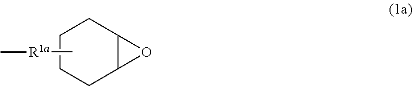
wherein R^{1a} represents linear or branched alkylene, 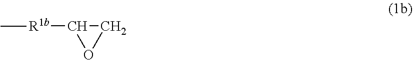
wherein R^{1b} represents linear or branched alkylene, 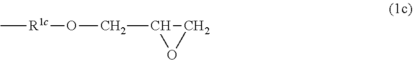
wherein R^{1c} represents linear or branched alkylene, 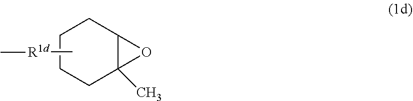
wherein R^{1d} represents linear or branched alkylene.

12. The hard coat film according to claim 7,
wherein the curable composition contains the epoxy compound in a proportion of 0.5 to 100 parts by weight per 100 parts by weight of the totality of the cationically curable silicone resin.

13. The hard coat film according to claim 7,
wherein the curable composition contains the cationically curable silicone resin and the epoxy compound in a total content of from 70 weight percent to less than 100 weight percent of the totality of the curable composition excluding solvents.

14. The hard coat film according to claim 1,
wherein the leveling agent includes a fluorine-containing leveling agent containing a polyether group.

15. The hard coat film according to claim 1,
wherein the leveling agent includes a fluorine-containing leveling agent containing a polyoxyethylene group.

16. The hard coat film according to claim 1,
wherein the curable composition contains the leveling agent in a proportion of 0.001 to 20 parts by weight per 100 parts by weight of the totality of the cationically curable silicone resin.

17. The hard coat film according to claim 1,
wherein the curable composition contains the cationically curable silicone resin in a content of from 50 weight percent to less than 100 weight percent of the totality of the curable composition excluding solvents.

18. The hard coat film according to claim 1,
wherein the hard coat film has a haze of less than 1.4%.

19. The hard coat film according to claim 1,
wherein the hard coat film has a flexibility of 40 mm or less, where the flexibility is measured with the hard coat layer facing inward, using cylindrical mandrels in accordance with JIS K 5600-5-1:1999.

20. The hard coat film according to claim 1,
wherein the hard coat layer has such a surface as not to be scratched even after 100 reciprocating sliding movements of steel wool #0000 having a diameter of 1 cm under a stress of 1.3 kg/cm².
